(19) United States
(12) Patent Application Publication
(10) Pub. No.: US 2002/0053090 A1
(43) Pub. Date: May 2, 2002

(54) Data receiving apparatus and data receiving method

(76) Inventors: Masataka Okayama, Fujisawa (JP); Tomohisa Kohiyama, Yokohama (JP); Harumi Morino, Yokohama (JP); Takeo Tomokane, Yokohama (JP)

Correspondence Address: Mattingly, Stanger & Malur, P.C., Suite 370, 1800 Diagonal Road, Alexandria, VA, 22314, US

(21) Appl. No.: 09/965,148

(22) Filed: Sep. 28, 2001

(30) Foreign Application Priority Data
Oct. 27, 2000 (JP) 2000-333537

(51) Int. Cl. H04N 7/16

(52) U.S. Cl. 725/152; 725/140

(57) ABSTRACT

A data receiving apparatus comprises a receiving unit which receives data, a storage unit which stores received data, and a CPU which secures in the storage unit an exclusive memory area exclusively usable by a service provider or a broadcasting provider.

### BACKGROUND OF THE INVENTION

1. Field of the Invention

The present invention relates to a data receiving apparatus and method which receive data transmitted via a broadcast wave or an electric communication line a data transmitting apparatus and a service center which transmit data to the data receiving apparatus.

2 Description of the Related Art

JP-A No. 259930/1999 discloses, as prior art, a program information recording apparatus which automatically records a part of a received program or the entire program, gives each program a priority level to inhibit or permit automatic erasure or data alteration and adequately adjusts the amount of storage data of memory means based on the priority level of the program. JP-A No. 259930/1999 also describes that the intention of a program information creator or broadcasting provider or the like is reflected on a process or an operation which is associated with a program on the receiver side. JP-A No. 259930/1999 further describes a method of replacing a commercial program or a method of replacing a weather forecast program.

While the art described in JP-A No. 259930/1999 reflects the intention of a program information creator or broadcasting provider or the like on a process or an operation which is associated with a program on the receiver side, no consideration is taken into the guarantee of the reflection of the intention. When the priority level that is determined based on personal information is higher than the priority level set on the sender side, for example, it is inferred that the intention of the program information creator or broadcasting provider or the like is not reflected at all. When the priority level set on the sender side is higher than the priority level that is determined based on personal information, on the other hand, it is inferred that the storage of information based on the intention of the program information creator or broadcasting provider or the like reduces the memory area usable by the receiver, thus eating up the memory area that should have been guaranteed to the receiver.

In case where a program is broadcast to a storage type receiving apparatus, data about the broadcast program and data about a commercial are separately broadcast. When a viewer is not interested in the commercial, therefore, it is expected that the viewer selectively views only the broadcast program without viewing the commercial or delete stored data about the commercial. If the viewer does not view the commercial, the sponsor for the broadcast program cannot improve the well-known degree of the product or service and cannot thus gain the profit from the advertisement of the commercial.

It is possible to provide a storage type receiving apparatus with not only the conventional program broadcasting but also a service of distributing contents, such as movies, music and games. For example, a content provider or sender distributes a content to each receiving apparatus using a broadcasting system and each receiving apparatus stores the distributed content. Generally, contents to be distributed undergo some kind of an encrypting process to prevent illegitimate copying, so that the stored content cannot be used directly. Therefore, a user buys a decryption key for decrypting the encrypted content from the content provider or sender or an agent thereof, decrypts the encrypted content using the decryption key and then uses the content. Buying the decryption key is equivalent to buying the content.

While the art described in JP-A No. 259930/1999 reflects the intention of a program information creator or broadcasting provider or the like on a process or an operation which is associated with a program on the receiver side, no consideration is taken into the guarantee of reliably providing a viewer with a content. When the priority level that is determined based on personal information is higher than the priority level that is set on the sender side, it is expected that the memory area that should store a content to be distributed is eaten up.

### OBJECTS AND SUMMARY OF THE INVENTION

Accordingly, it is an object of the invention to provide a data receiving apparatus and a data receiving method which can allow a data provider or sender to reliably provide a viewer (user) with a service (information, a product or the like).

The invention secures an exclusive memory area exclusively usable by a data provider or sender in a data receiving apparatus. The “data provider” is, for example, a service provider, a sponsor for a broadcast program or an information provider. The “data sender” is, for example, a network provider, a broadcasting provider or a CATV (Cable Television) provider. Preferably, the exclusive memory area is subjected to restriction of at least one of data writing, data reading and data alteration based on an instruction made by the user of the data receiving apparatus. It is preferable that a plurality of exclusive memory areas are provided respectively for a plurality of providers or senders. Preferably, data a provider or sender wants to store in the exclusive memory area is stored in the exclusive memory area. It is preferable that the data receiving apparatus should have a user memory area which stores received data in accordance with an instruction made by the user of the data receiving apparatus. It is preferable to separate the exclusive memory area from the user memory area logically or physically. The exclusive memory area stores, for example, sub data about a commercial, commodity sales, service providing offer, commodity or service catalog. The user memory area stores, for example, main data about a broadcast program. It is preferable that sub data should be displayed in linkage with the main data. For example, sub data is displayed in the form that it is inserted in the main data. It is preferable to replace sub data to be included in the main data.

Because the invention has an exclusive memory area, the intention of a data provider or sender in association with processing of received data can be guaranteed.

The invention restricts at least one of alteration and deletion of data about a commercial, commodity sales, service providing offer, commodity or service catalog based on an instruction made by the user of the data receiving apparatus. That is, even without an exclusive memory area, at least one of alteration and deletion of data about a commercial or the like based on an instruction made by the user of the data receiving apparatus is restricted.

Because at least one of alteration and deletion of data about a commercial or the like is restricted according to the invention, the intention of a data provider or sender in association with processing of data about a commercial or the like can be guaranteed.

According to the invention, a data transmitting apparatus transmits a data receiving apparatus associated data for associating exclusive data to be stored in an exclusive memory area with user data to be stored in a user memory area. The associated data may be transmitted in a form in which it is added to exclusive data or in which it is added to user data, or may be transmitted as a table. According to the invention, a service center apparatus determines that an exclusive memory area is secured in a data receiving apparatus.

According to the invention, the selling price of a data receiving apparatus, which has an exclusive memory area, the price of pay data to be transmitted to this data receiving apparatus and the price of an electric communication line connected to the data receiving apparatus are set lower than those which are associated with a data receiving apparatus that does not have an exclusive memory area. According to the invention, the selling price of a data receiving apparatus, for which at least one of an entire memory capacity and entire storage time duration of an exclusive memory area is large, the price of pay data to be transmitted to this data receiving apparatus and the price of an electric communication line connected to the data receiving apparatus are set lower than those which are associated with a data receiving apparatus for which at least one of the entire memory capacity and entire storage time duration of the exclusive memory area is small.

The invention can increase the added value of the data receiving apparatus that has an exclusive memory area and promote the desire to buy the data receiving apparatus having the exclusive memory area or helps urge the desire to set the exclusive memory area of the data receiving apparatus. This can guarantee the intention of a data provider or sender in association with processing of received data. It is also possible to promote the widespread use of the data receiving apparatus.

According to the invention, as a data provider or sender a predetermined memory capacity or storage time duration is guaranteed for an exclusive memory area exclusively usable by a provider or sender of data, a fee is obtained from the data provider or sender. The fee is, for example, money, a negotiable security, a bond or the like.

The invention can reduce the selling price of the data receiving apparatus that has an exclusive memory area and promote the desire to buy the data receiving apparatus having the exclusive memory area or helps urge the desire to set the exclusive memory area of the data receiving apparatus. This can guarantee the intention of a data provider or sender in association with processing of received data. It is also possible to promote the widespread use of the data receiving apparatus.

Other and further objects, features and advantages of the invention will appear more fully from the following description.

### BRIEF DESCRIPTION OF THE DRAWINGS

A preferred form of the present invention illustrated in the accompanying drawings in which:

FIG. 1 is a structural diagram of a service system according to one embodiment;

FIG. 2 is a hardware structural diagram of a data storage type data receiving apparatus according to the embodiment;

FIG. 3 is a structural diagram of software which operates on the data storage type data receiving apparatus according to the embodiment;

FIG. 4 is a diagram illustrating a process flowchart of exclusive-memory-area managing means according to the embodiment;

FIG. 5 is a diagram showing the contents of an exclusive-memory-area management table according to the embodiment;

FIG. 6 is a diagram illustrating a process flowchart of write control means according to the embodiment;

FIG. 7 is a diagram showing the contents of a pre-scheduled recording list table according to the embodiment;

FIG. 8 is a diagram showing the contents of CM-data management table according to a first embodiment;

FIG. 9 is a diagram illustrating a process flowchart of CM replacing means according to the first embodiment;

FIG. 10 is a software structural diagram according to the first embodiment;

FIG. 11 is a diagram illustrating a process flowchart of program recording means according to a fourth embodiment;

FIG. 12 is a software structural diagram according to the fourth embodiment;

FIG. 13 is a diagram showing the contents of a recorded-program management table according to the fourth embodiment;

FIG. 14 is a diagram illustrating a process flowchart of program reproducing means according to the fourth embodiment;

FIG. 15 is a diagram showing the contents of an exclusive-memory-area management table according to a second embodiment;

FIG. 16 is a diagram illustrating a process flowchart of write control means according to the second embodiment;

FIG. 17 is a diagram illustrating a process flowchart of exclusive-memory-area managing means according to the second embodiment;

FIG. 18 is a hardware structural diagram of a data storage type data receiving apparatus according to a third embodiment;

FIG. 19 is a diagram illustrating a process flowchart of exclusive-memory-area managing means according to the third embodiment;

FIG. 20 is a diagram illustrating a process flowchart of write control means according to the third embodiment;

FIG. 21 is an explanatory diagram of a program structure according to the fourth embodiment;

FIG. 22 is a diagram showing program attribute information describing the program structure according to the fourth embodiment;

FIG. 23 is a diagram showing the contents of a CM list according to the fourth embodiment;

FIG. 24 is a diagram showing the contents of nodes that constitute the CM list according to the fourth embodiment;

FIG. 25 is a diagram showing the contents of a CM list according to the fourth embodiment;

FIG. 26 is a diagram exemplifying a screen for explaining a method of securing/deleting an exclusive memory area according to the embodiment;

FIG. 27 is a diagram exemplifying another screen for explaining the method of securing/deleting the exclusive memory area according to the embodiment;

FIG. 28 is a hardware structural diagram of a charge server according to the embodiment;

FIG. 29 is a diagram showing the contents of a client information management table according to the embodiment;

FIG. 30 is a diagram showing the contents of a charge information management table according to the embodiment;

FIG. 31 is a hardware structural diagram of a distribution server according to the embodiment;

FIG. 32 is a diagram showing the contents of a content management table according to the embodiment;

FIG. 33 is a diagram showing the contents of the data structure of communication data according to the embodiment;

FIG. 34 is a diagram illustrating a process flowchart of communication data processing means according to the embodiment;

FIG. 35 is a diagram showing the contents of a movie-content management table according to a fifth embodiment;

FIG. 36 is a diagram showing the contents of a stored-content management table according to the fifth embodiment;

FIG. 37 is a diagram illustrating a process flowchart of content viewing/buying means according to the fifth embodiment;

FIG. 38 is a diagram exemplifying a screen for explaining the content viewing/buying method according to the fifth embodiment; and

FIG. 39 is a diagram exemplifying another screen for explaining the content viewing/buying method according to the fifth embodiment.

### DETAILED DESCRIPTION OF THE PREFERRED EMBODIMENTS

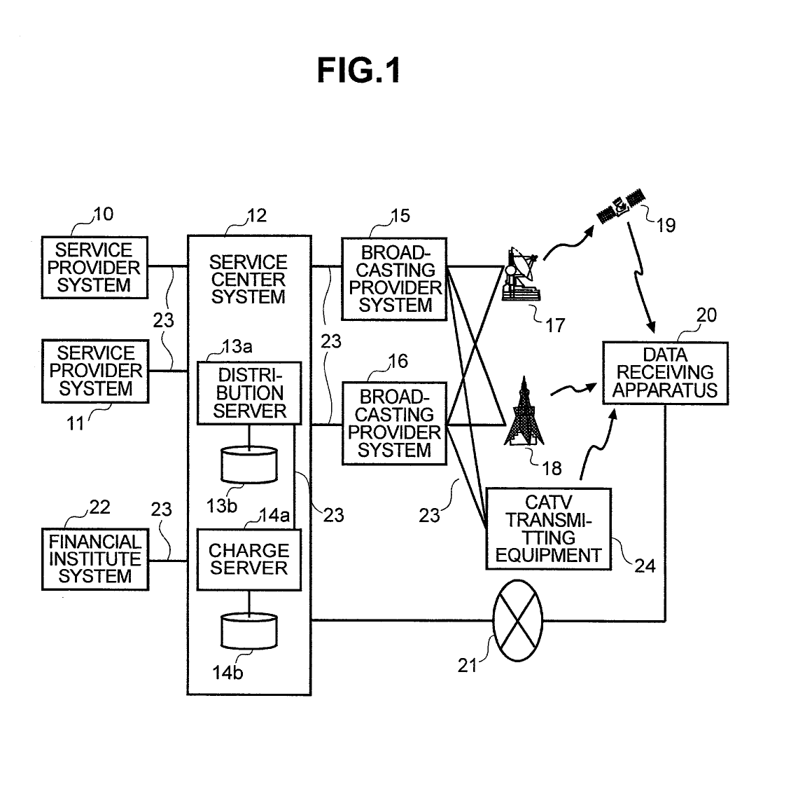

FIG. 1 is a structural diagram of a data storage type service system to which a data storage type service scheme according to one embodiment is adaptable.

In FIG. 1, this service system comprises service provider systems 10 and 11, which provide a user of a data receiving apparatus 20 with services, a service center system 12, a distribution server 13a which distributes content data, a content database 13b which stores content data, a charge server 14a which makes a charge for a request made by the user of the data receiving apparatus 20, a client database 14b which stores information about the user of the data receiving apparatus 20, broadcasting provider systems 15 and 16 which broadcast programs, commercials and other data, an analog or digital satellite broadcasting equipment 17, a ground wave broadcasting equipment 18, a broadcasting satellite (BS) 19, the data receiving apparatus 20 which receives broadcast programs, commercials and other data, communication networks 21 and 23 (telephone line, optical fiber, etc.) which use cables or radio waves, a financial institute system 22 and a CATV (Cable Television) transmitting equipment 24.

The service center system 12 has the distribution server 13a, the content database 13b, the charge (or client managing) server 14a, and the client database 14b. A service provider is, for example, a sponsor for a broadcast program. The broadcasting provider systems 15 and 16 may distribute not only a broadcast program (e.g., video) but also data (e.g., character data or image data) or a content (e.g., a movie, music or game). The broadcasting satellite 19 may be a communication satellite (CS). The communication networks 21 and 23 may be a public line or a private line as well. The communication network 23 that connects individual components of the data storage type service system maybe different lines for the individual components. For example, the network 23 that connects the service provider system 10 to the service center system 12 may be different from the network that connects the distribution server 13a to the charge server 14a. The user of the data receiving apparatus 20 is, for example, a viewer of a broadcast program or a buyer of a distributed content. The broadcasting provider may be an Internet provider. In case where the broadcasting provider is an Internet provider, the broadcasting provider systems 15 and 16 and the data receiving apparatus 20 are connected via a network (which may be the network 21), such as the Internet.

According to the data storage type service system of the invention, content data which at least one service provider holds is transmitted to the service center system 12 from the service provider system 10 or 11 via the network 23. The content data held by a service provider is, for example, data about a commercial, commodity sales, service providing offer, commodity or service catalog. The content data that is received by the service center system 12 is stored in the content database 13b located in the service center system 12. It is preferable that the service center system 12 should add an identifier for identifying a service provider to content data. The distribution server 13a located in the service center system 12 transmits content data to at least one broadcasting provider system 15 or 16 via the network 23 according to a predetermined distribution schedule. The broadcasting provider system 15 or 16 transmits the content data to the data receiving apparatus 20 from the satellite broadcasting equipment 17, the ground wave broadcasting equipment 18 or the CATV transmitting equipment 24 according to a predetermined broadcasting schedule. The broadcasting provider system 15 or 16 may broadcast data which has a commercial or the like inserted in a broadcast program or may separately broadcast data about a broadcast program and data about a commercial. In case where data about a broadcast program and data about a commercial are broadcast in the same broadcast packet or over the same broadcast channel, it is preferable to broadcast them at different broadcasting time zones. Further, a broadcast packet of data about a broadcast program or a broadcast channel for that data may be made different from a broadcast packet of data about a commercial or a broadcast channel for that data. Furthermore, data about a broadcast program and data about a commercial may be broadcast in a multiplexed form.

The data receiving apparatus 20 receives a broadcast program, commercial and other data, and stores content data in an incorporated storage unit (for example, a hard disk unit). The storage unit may be designed in such a way as to be attachable to and detachable from the data receiving apparatus 20 which is provided with a special connector in this case. The data receiving apparatus 20 can display received content data on a display unit in real time without storing the data in the storage unit. In case where the received content data is a pay type and a user want to pay for it, the data receiving apparatus 20 sends information indicating that the user has bought the content data together with an identifier identifying the content to the service center system 12 via the network 21. The charge server 14a located in the service center system 12 collates the purchase information with client information and charge information of the content, both stored in the client database 14b, and finally, the user is charged with the fee set for the content data from the financial institute system 22 that is connected via the network 23 to the service center system 12. It is preferable that the user should apply for provision of a service to the service center system 12 using the data receiving apparatus 20. The client database 14b stores client information about the user of the data receiving apparatus 20 connected to the network 21. The “client information” includes, for example, information indicating whether or not an exclusive memory area is secured in the data receiving apparatus 20, the capacity of the exclusive memory area, attribute information of the user (address, age, sex, place of contact and occupation), the data reception history of the user, the view history (reproduction history) and other data (preferred by the user).

The user of the service center and a broadcasting provider may be the same. In this case, the service center system 12 is located in the broadcasting provider system 15 or 16.

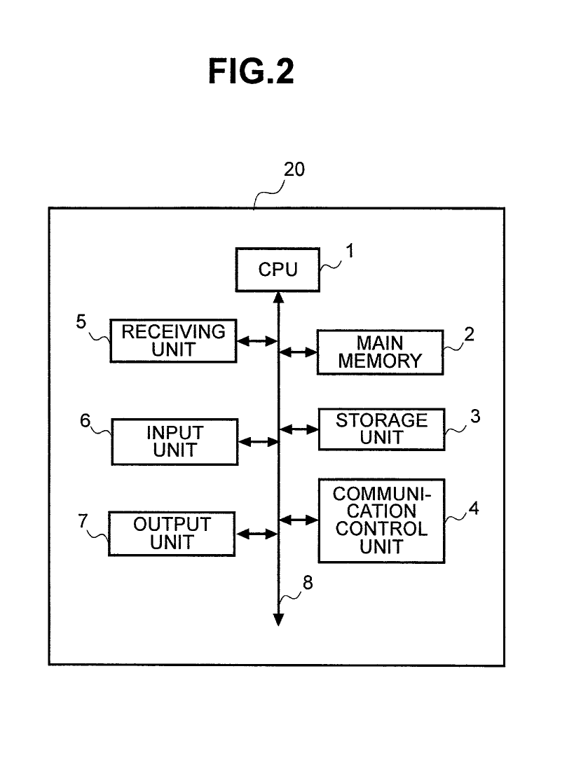

FIG. 2 is a hardware structural diagram of the data receiving apparatus 20 to which the data storage type data receiving apparatus according to the embodiment can be adapted.

As shown in FIG. 2, the data receiving apparatus 20 comprises a CPU (Central Processing Unit) 1, a main memory 2, a storage unit 3, a communication control unit 4, a receiving unit 5, an input unit 6 and an output unit 7. The individual components of the data receiving apparatus 20 are connected together by a bus 8 so that necessary information can be transferred among the individual components.

The CPU 1 executes a predetermined process according to a program stored beforehand in the main memory 2 or the storage unit 3.

The main memory 2, which is means that serves as a work area or stores a necessary program, may be realized by, for example, a RAM (Random Access Memory) for the former purpose and a ROM (Read Only Memory) for the latter purpose.

The storage unit 3 is means for storing a program for controlling the operation of the data receiving apparatus 20 and stores content data broadcast (distributed) by a broadcasting provider. While the storage unit 3 is preferably a hard disk drive, an optical disk drive (DVD-RW (Digital Versatile Disc Rewritable) drive, DVD-RAM drive, DVD-Blue drive, CD-RW (CD-Rewritable) drive or the like), a magnetic medium drive (floppy disk drive or the like) or a magneto-optical (MO) disk drive, it maybe a semiconductor memory device (ROM, RAM or the like). The storage unit 3 can have or secure a plurality of memory areas physically or logically separated from one another. The “physically separated memory areas” means a plurality of recording media. The “logically separated memory areas” means a single recording medium or a plurality of recording media that are collectively managed. The storage unit 3 may be detachable from (attachable to and detachable from) the data receiving apparatus 20. That is, the user can replace one storage unit 3 with another storage unit 3. In case where there are a plurality of service providers, for example, attachable and detachable recording media corresponding to the respective service providers may be provided so that the recording media are replaceable with one another as needed.

The communication control unit 4 is means for transmitting and receiving information (data) to and from a unit connected thereto via network, such as a telephone line, LAN (Local Area Network) or WAN (Wide Area Network). The communication control unit 4 is realized by, for example, a modem, a network adapter, a radio transmitter/receiver or the like.

The receiving unit 5 is means for receiving an analog or digital satellite broadcast wave, an analog or digital ground broadcast wave, or an analog or digital CATV broadcast wave. As analog satellite broadcasting, there is analog BS (Broadcasting Satellite) broadcasting which is already available in Japan. As digital satellite broadcasting, there is digital CS (Communication Satellite) broadcasting which is already available in Japan and digital BS broadcasting which has started since December of 2000. As analog ground broadcasting, there are analog ground TV broadcasting systems, such as NTSC (National Television System Committee) that is used worldwide, PAL (Phase Alternating Line) and SECAM (Sequential Couleur a Memoire), and CATV broadcasting using an exclusive cable. As digital ground broadcasting, there is ATSC (Advanced Television Systems Committee) digital ground broadcasting that is already available in the U.S.A. In the description of the embodiment that will be discussed later, the receiving unit 5 will be described as a receiving unit designed for BS digital broadcasting. It is needless to say that the invention is not limited to digital BS broadcasting and the receiving unit 5 may be so designed as to be able to receive waves of plural broadcasting forms.

The input unit 6 is means which allows the user to input necessary instructions or information to the data receiving apparatus 20. The input unit 6 is achieved by, for example, a remote controller which is used for a TV receiver, or a keyboard, a mouse, a touch panel or the like which is used for a personal computer (PC).

The output unit 7 (display unit) is means for displaying content data stored in the storage unit 3 or information for responding to an operation by the user. The output unit 7 can be achieved by a Braun tube, CRT (Cathode Ray Tube), liquid crystal display, PDP (Plasma Display Panel), projector, EL display or the like.

In case the components of the data receiving apparatus 20 include components which are not directly associated with the input/output of data and a program, such components can be removed from the structure shown in FIG. 2.

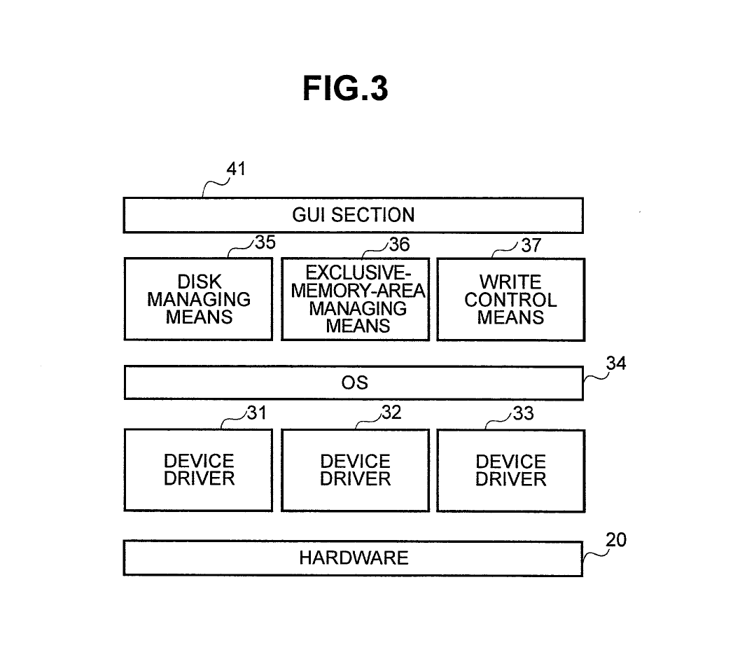

FIG. 3 is a structural diagram of software which operates on the data receiving apparatus 20.

In FIG. 3, reference numerals “31”, “32” and “33” denote device drivers and there is at least one device driver for each of the components of the data receiving apparatus 20, excluding the CPU 1 and the main memory 2. As the data receiving apparatus 20 shown in FIG. 2 has the storage unit 3, the communication control unit 4, the receiving unit 5, the input unit 6 and the output unit 7, for example, there are a total of five device drivers each for a corresponding component. The device drivers are programs which control exchange of data among the individual components (including the CPU 1 and the main memory 2) of the data receiving apparatus 20 via the bus 8.

An OS (Operating System) 34 is a program which performs memory management, task management and processes, such as an interruption process, to the individual components of the data receiving apparatus 20.

Disk managing means 35 is a program which manages, a file, directory, folder and so forth which are read or written from or in the storage unit 3. While the device driver for the storage unit 3 is a program which depends on hardware, the disk managing means 35 is a program which does not depend on the type of the storage unit 3 and accomplishes logical functions. The disk managing means 35 may be realized as one function of the OS 34.

Exclusive-memory-area managing means 36 is a program which secures or deletes part of the area of the storage unit 3 as an exclusive area for a service provider.

The “exclusive memory area” is a memory area which can be exclusive used (for data writing, reading, alteration, deletion, etc.) by a service provider or a broadcasting provider and can be used by the user of the data receiving apparatus. That is, the exclusive memory area is subjected to restriction of data writing, reading, alteration, deletion, etc. based on an instruction made by the user of the data receiving apparatus. The exclusive memory area may be replaced with a priority memory area which a service provider or a broadcasting provider can used by priority with respect to the user of the data receiving apparatus and which can also be used by the user of the data receiving apparatus according to the priority level.

Write control means 37 is a program which controls data writing in the exclusive memory area by the user (viewer).

A GUI (Graphical User Interface) section 41 is a program which displays an interface for allowing the user to perform an operation and inform the device drivers, the OS and so forth of the contents of the user operation.

The individual software programs shown in FIG. 3 are stored in the main memory 2 or the storage unit 3 and are executed by the CPU 1, for example, upon reception of an instruction (operation) from the user that is made using the input unit 6, at the time of switching the main power source on or upon reception of a content data signal.

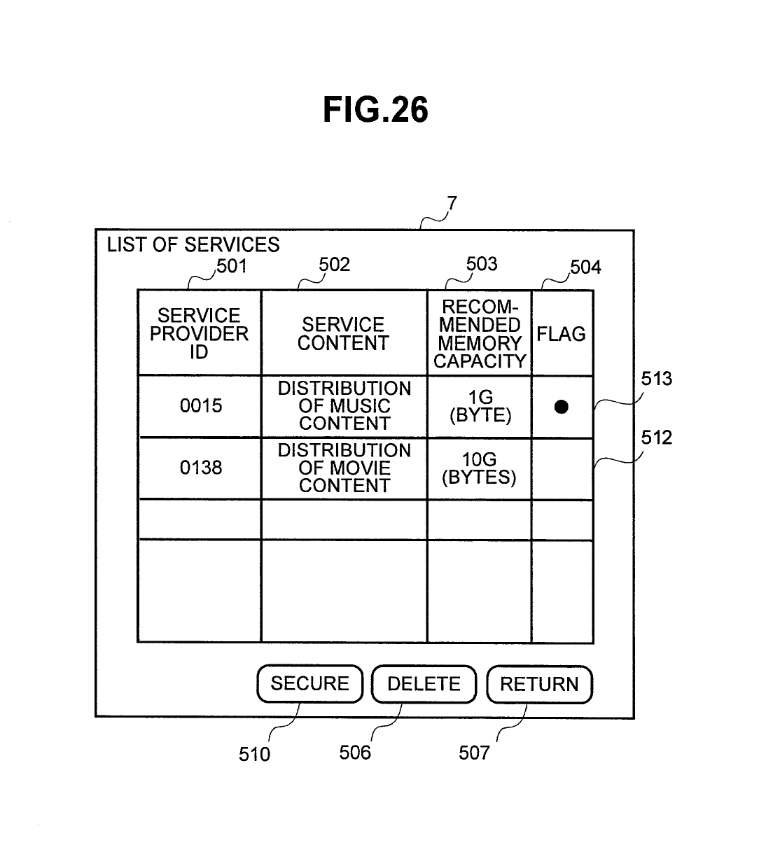

The content of the service that is provided by the data storage type service system is transmitted the data receiving apparatus 20 as data broadcast by, for example, the broadcasting provider system 15 or 16. In the aforementioned BS digital broadcasting, data to be transmitted is described based on a predetermined format. The data receiving apparatus 20 receives broadcast data by the receiving unit 5 and decodes the data described based on the format. After data indicating the service content which is transmitted in data broadcasting is decoded by the data receiving apparatus 20, a screen shown in FIG. 26 is displayed on the output unit 7 as a list of services, for example. For each service provided at present, the data indicating the service content which is transmitted in data broadcasting includes at least a service provider name or service provider ID (identifier) 501, a service content 502, and a recommended memory capacity or storage time duration 503 for the exclusive memory area that is necessary for the service. Further displayed is a flag 504 which indicates whether or not the exclusive memory area has already been secured in the data receiving apparatus 20. For example, the flag 504 can be expressed by an icon, graphic data or the like, and different icons, graphic data or the like are used for a service for which the exclusive memory area has already been secured and a service for which the exclusive memory area has not been secured yet. Alternatively, an icon, graphic data or the like may be displayed only for a service for which the exclusive memory area has already been secured. FIG. 26 shows that the exclusive memory area has not been secured yet for a service 512 and the exclusive memory area already been secured yet for a service 513.

The user can select a service in the service list using the input unit 6. In this case, changing the form of the display for the selected service from the form of the display for unselected services makes easier for the user to identify the selected service. FIG. 26 shows the service 512 selected and the service 513 unselected.

Further, the data indicating the service content which is transmitted in data broadcasting includes information for displaying at least a SECURE button 505, a DELETE button 506 and a RETURN button 507. The data receiving apparatus 20 displays those buttons on the output unit 7, for example, as shown in FIG. 26.

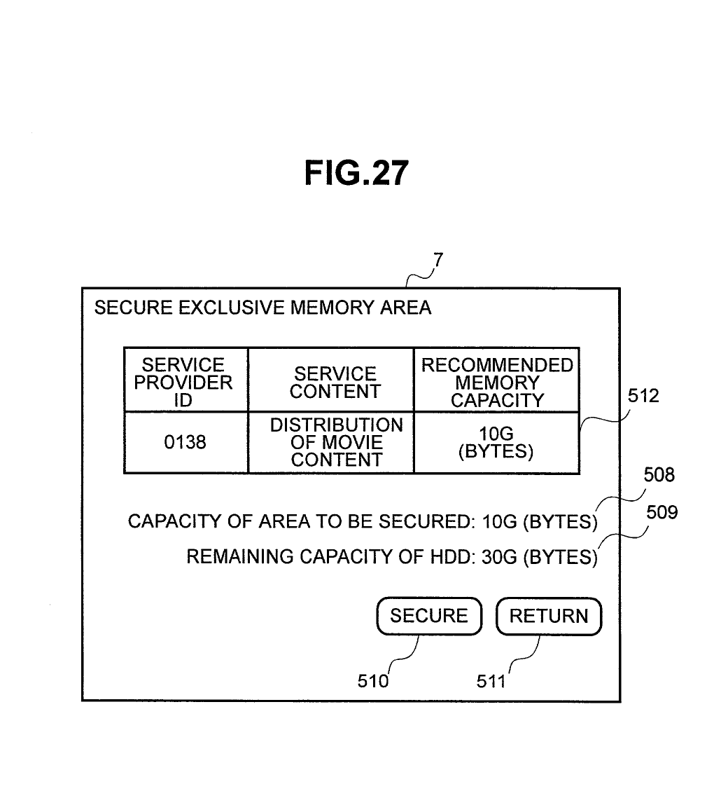

When the user specifies the RETURN button 507 using the input unit 6, the data receiving apparatus 20 displays on the output unit 7 a screen (e.g., a TV display screen or the like) which appears immediately before the service list shown in FIG. 26 is displayed. Likewise, when the user specifies the DELETE button 506, an exclusive memory area, if secured for the selected service, is deleted. If an exclusive memory area is not secured for the selected service, no processing is performed. In case where an exclusive memory area is not secured for the selected service, designation of the DELETE button 506 may be inhibited. Likewise, when the user specifies the SECURE button 505, a screen, for example, shown in FIG. 27 is displayed on the output unit 7. As shown in FIG. 27, the data receiving apparatus 20 displays the service provider name or service provider ID 501 and the service content 502 for the selected service, and the recommended memory capacity or storage time duration 503 for the exclusive memory area that is needed for the service. Further, a memory capacity or storage time duration 508 for the exclusive memory area to be secured and an unused memory capacity or remaining storage time duration 509 of the storage unit 3 that is currently available are displayed. The user enters the available memory capacity or storage time duration by using the input unit 6. At this time, it is desirable that the content of the recommended memory capacity or storage time duration 503 of the exclusive memory area that is needed for the service should have already been described as a default value in the memory capacity or storage time duration 508. FIG. 27 also shows a SECURE button 510 and a RETURN button 511 so that when the user specifies the RETURN button 511 using the input unit 6, the data receiving apparatus 20 displays the screen that shows the service list shown in FIG. 26. Likewise, the user specifies the SECURE button 510, the data receiving apparatus 20 secures the capacity indicated by the memory capacity or storage time duration 508 of the exclusive memory area to be secured in the area of the storage unit 3 for the service (service 512).

In case where an exclusive memory area has already been secured for the selected service when the SECURE button 505 is specified in FIG. 26, the data receiving apparatus 20 does nothing or displays the screen shown in FIG. 27. In this case, the screen in FIG. 27 becomes a screen for altering the exclusive memory area. It is desirable at this time that the recommended memory capacity or storage time duration of the exclusive memory area that has already been secured for the service should have already been described as a default value in the memory capacity or storage time duration 508. When the SECURE button 510 in FIG. 27 is further specified, the data receiving apparatus 20 reallocates an exclusive memory area to the service.

The following describes the operations of the exclusive-memory-area managing means 36 to secure and cancel part of the area of the storage unit 3 as an exclusive area for a service provider (the operations when the SECURE button 510 and the DELETE button 506 in FIG. 27 are specified).

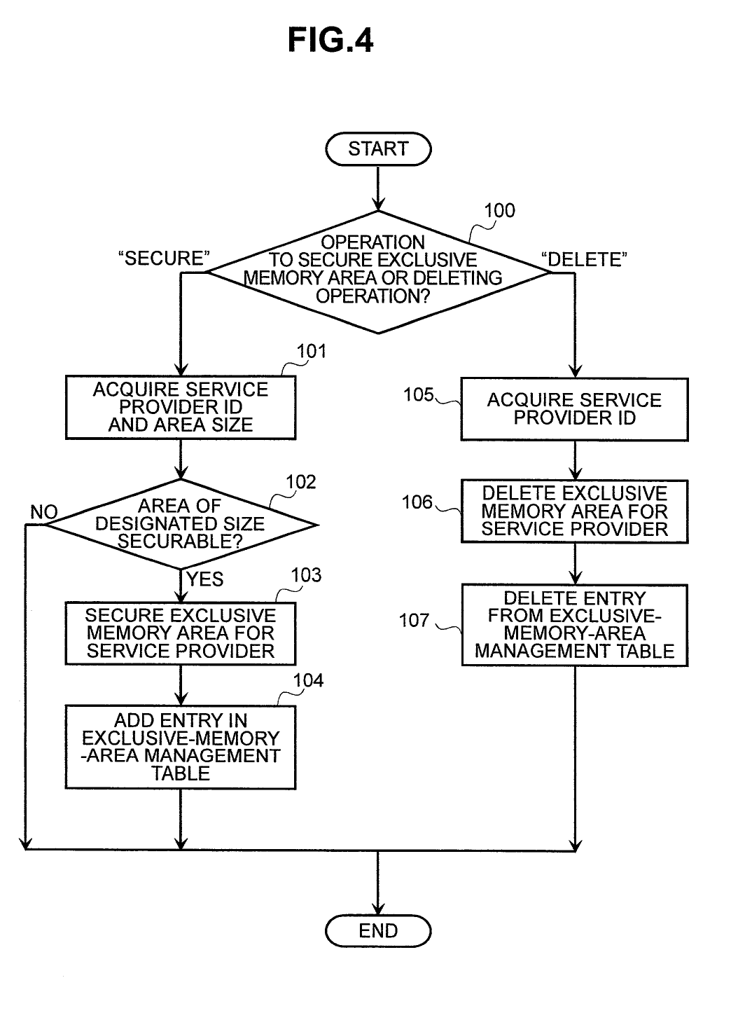

FIG. 4 illustrates a process flowchart of the exclusive-memory-area managing means 36.

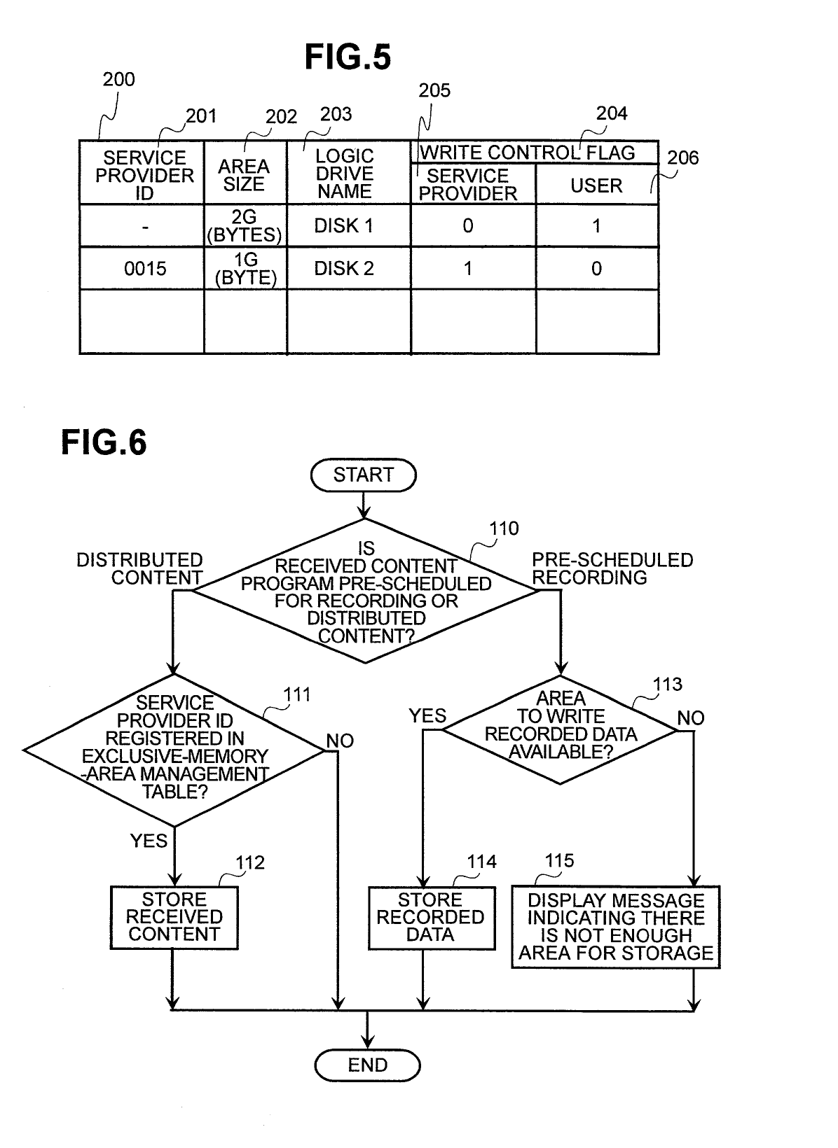

The exclusive-memory-area managing means 36 is activated when the SECURE button 510 on the screen in FIG. 27 displayed by the GUI section 41 is specified or when the DELETE button 506 on the screen in FIG. 26 displayed by the GUI section 41 is specified. As shown in FIG. 4, the exclusive-memory-area managing means 36 first determines whether or not it is a memory-area securing operation or a memory-area deleting operation (step 100). When the operation is the memory-area securing operation (when the SECURE button 510 is specified), the exclusive-memory-area managing means 36 acquires the content of the service provider name or service provider ID 501 and the content of the memory capacity or storage time duration 508 (step 101). The exclusive-memory-area managing means 36 then determines whether or not it is possible to secure in the storage unit 3 an area corresponding to the memory capacity or storage time duration for the exclusive memory area to be secured (step 102). When such is not possible (when there is no area remained in the storage unit 3 to secure the exclusive memory area), the exclusive-memory-area managing means 36 prompts the user to make an input again. When the exclusive memory area is securable in the storage unit 3 in step 102, the exclusive memory area is secured in part of the area of the storage unit 3 (step 103). At this time, the securing of the area is carried out by the disk managing means 35. As the disk managing means 35 secures the area, a logical drive name that indicates the area is assigned. Next, the exclusive-memory-area managing means 36 adds an entry corresponding to the secured area in an exclusive-memory-area management table 200 (step 104), then terminates the process. FIG. 5 shows the contents of the exclusive-memory-area management table 200.

Referring to FIG. 5, the exclusive-memory-area management table 200 comprises a service provider ID 201, an area size (memory capacity or storage time duration) 202, a logic drive name 203 and a write control flag 204. Note that the exclusive memory area, once secured, need not always be located in consecutive sectors starting at a specific head address but may be dispersed at plural addresses. For example, in response to an instruction to write data in the exclusive memory area, the head address of data to be written is determined. In other words, an exclusive memory area of a predetermined size has only to be guaranteed for the service provider or broadcasting provider.

A unique ID which is given to every service provider is set in the service provider ID 201. If the content of the service provider name or service provider ID 501 is a service provider name in FIG. 26, a table which shows the correlation between the service provider name and the corresponding ID is held in the storage unit 3 or the like and the service provider ID is acquired. It is assumed that the table that shows the correlation between the service provider name and the corresponding ID has externally been sent beforehand via the communication control unit 4 or the receiving unit 5 and has been stored in the storage unit 3.

The size of the area that is actually secured based on the size (memory capacity or storage time duration) specified by the user is set in the area size 202. The entire memory area of the storage unit 3 may be set as the exclusive memory area or part of the memory area of the storage unit 3 may be set as the exclusive memory area. When the entire memory area of the storage unit 3 is set as the exclusive memory area, there is no memory area usable by the user in the memory area of the storage unit 3. When part of the memory area of the storage unit 3 is set as the exclusive memory area, a memory area other than the exclusive memory area is a memory area usable by the user (user memory area) Normally, it is preferable to display the entire size, the used memory size, the unused memory size or the like of the user memory area, but not to display the entire size, the used memory size or the unused memory size or the like of the exclusive memory area. The “used memory size” is the size of the memory area in the entire exclusive memory area where content data is stored, and the “unused memory size” is the size obtained by subtracting the used memory size from the entire size of the exclusive memory area.

The entire size of the exclusive memory area is notified to the charge server 14a of the service center system 12 via the communication control unit 4 when the exclusive memory area is secured. The service center system 12 may notify the entire size of the exclusive memory area to the service provider system 10 or the broadcasting provider system 15 or 16. At the time the exclusive memory area is secured, only information indicating the exclusive memory area having been secured may be notified to the charge server 14a. The distribution server 13a can select a distributed content based on the size of the exclusive memory area notified to the charge server 14a. That is, when the size of content data is larger than the size of the exclusive memory area, it is possible to determine that the large-sized content data, if sent to the data receiving apparatus 20, cannot be stored in the exclusive memory area. In case where a plurality of exclusive memory areas are present, it is preferable to notify the usable size for each exclusive memory area. The used memory size or the unused memory size of the exclusive memory area may be notified to the charge server 14a. The data receiving apparatus 20 may notify the entire size, the used memory size or the unused memory size of the exclusive memory area to the charge server 14a in accordance with a predetermined schedule or an instruction made by the user or when a damage on the recording medium of the storage unit 3 is detected. Alternatively, the charge server 14a may send a request to the data receiving apparatus 20 in accordance with a predetermined schedule or an instruction made by the service provider, and the data receiving apparatus 20 may send the entire size, the used memory size or the unused memory size of the exclusive memory area to the charge server 14a upon reception of the request. It is preferable that a part of the charge for the usage of the network that is needed for the notification of the usable size or the like or the entire charge should be paid by the service provider, the broadcasting provider or an agent thereof (a managing person in the service center).

When the storage unit 3 is constructed by an HDD, a damage, such as a sector failure of the HDD, may occur over a long usage, which may lead to reducing the size of the usable area of the exclusive memory area. In this case, notifying the substantial usable size to the charge server 14a via the communication control unit 4 at a given interval can allow the charge server 14a to always grasp the latest usable memory size. The “usable memory size” is the entire size of the exclusive memory area and is normally the initial size when the exclusive memory area has been secured, but when there is a damage, it is what is obtained by subtracting the size of an unwritable memory area that has resulted from the damage from the entire size. Even when data is recorded in the exclusive memory area, therefore, the usable memory size of the exclusive memory area does not change.

The data receiving apparatus 20 may store the reception history, recording history and viewing history (reproduction history) of data in the storage unit 3 and transmit those histories to the charge server 14a of the service center system 12. The service center system 12 may transmit the reception history, recording history and viewing history (reproduction history) of data from the data receiving apparatus 20 to the service provider system 10 or 11 or the broadcasting provider system 15 or 16. The data receiving apparatus 20 may notify the reception history, recording history and viewing history (reproduction history) of data to the charge server 14a in accordance with a predetermined schedule or an instruction made by the user. Alternatively, the charge server 14a may send a request to the data receiving apparatus 20 in accordance with a predetermined schedule or an instruction made by the service provider, and the data receiving apparatus 20 may send those histories to the charge server 14a upon reception of the request.

A drive name generated by the disk managing means 35 for accessing to a secured area is set in the logic drive name 203.

Set in the write control flag 204 is information indicating whether or not the service provider and the user can write some kind of data. The write control flag 204 has two entries, a service provider 205 and a user 206, which respectively indicate whether or not the service provider and the user can write data. The area writable by the service provider (exclusive memory area) means that content data from the service provider is received by the receiving unit 5 and can be stored in the area. The area writable by the user (user memory area) means that some kind of data corresponding to an operation made by the user can be stored in the area. In case where the user records a broadcast program to be received by the receiving unit 5, for example, the recorded data can be stored in the mentioned area. Data to be stored in the exclusive memory area may be stored in the user memory area. The data that should be stored in the exclusive memory area but is stored in the user memory area can be subjected to processes, such as reading, alteration and deletion, in accordance with an instruction from the user.

With the contents of the service provider ID 201, the area size 202, the logic drive name 203 and the write control flag 204 as a set (entry), the exclusive-memory-area management table 200 is finally constructed by zero or more entries. In the example shown in FIG. 5, an area with the logic drive name of DISK1 is an area which is not writable by both the service provider and the user. An area with the logic drive name of DISK2 is an area which is writable by the service provider but is not writable by the user.

Returning to FIG. 4, when the user's operation is “DELETE” (when the DELETE button 506 is specified) in step 100, the exclusive-memory-area managing means 36 further acquires the content of the service provider name or service provider ID 501 with respect to the selected service (step 105). Then, an entry which matches with the ID from the exclusive-memory-area management table 200 is acquired (when the content of the service provider name or service provider ID 501 is a service provider name, the name is converted to a service provider ID), and an area indicated by the entry is deleted (step 106). Deletion here means that the exclusive memory area becomes usable as a user memory area or usable as an exclusive memory area for another service provider or broadcasting provider. This process is executed by the disk managing means 35.

Then, the exclusive-memory-area managing means 36 deletes the entry for the area deleted from the exclusive-memory-area management table 200 (step 107), and terminates the process.

The data receiving apparatus 20 may secure or delete an exclusive memory area in the storage unit 3 in response to a request from the service center system 12. The data receiving apparatus 20 may change (increase or decrease) the size of the exclusive memory area in accordance with an instruction made by the user or in accordance with a request made by the service center system 12. When the size of the exclusive memory area is changed in accordance with an instruction made by the user, it is preferable that the data receiving apparatus 20 should notify the changed size of the exclusive memory area to the charge server 14a.

An exclusive memory area may be secured in the data receiving apparatus 20 beforehand (before the user acquires the data receiving apparatus 20).

The operation of the write control means 37 is discussed below.

FIG. 6 is a diagram illustrating a process flowchart of the write control means 37.

The write control means 37 is activated, for example, when content data is received, as in case where a broadcast program has been pre-scheduled for recording and when a pre-scheduled date has come, or when content data to be stored in the exclusive memory area of the service provider is received.

As shown in FIG. 6, the write control means 37 first determines whether the received content data is broadcast program data pre-scheduled for recording by the user or content data distributed from a service provider (step 110). Pre-scheduled recording information is stored in the storage unit 3 beforehand as a pre-scheduled recording list table. When content data is received, the write control means 37 checks the received content data against the pre-scheduled recording list table and determines that the received content data is a program pre-scheduled for recording by the user (data to be stored in the user memory area) when the received content data is described in the pre-scheduled recording list table. When the received content data is not described in the pre-scheduled recording list table, the write control means 37 determines the received content data is content data distributed from the service provider (data to be stored in the exclusive memory area). An identifier (data attribute ID) for identifying data to be stored in the exclusive memory area may be added to content data before transmission by the broadcasting provider system 15 or 16, and the data receiving apparatus 20 may determine whether or not the content data should be stored in the exclusive memory area based on the data attribute ID. The broadcasting provider system 15 or 16 may broadcast data to be stored in the user memory area and data to be stored in the exclusive memory area over different broadcast channels, and the data receiving apparatus may determine whether or not the content data should be stored in the exclusive memory area based on the broadcast channel. The broadcasting provider system 15 or 16 may separately broadcast a broadcast packet of data to be stored in the user memory area and a broadcast packet of data to be stored in the exclusive memory area, and the data receiving apparatus may determine whether or not the content data should be stored in the exclusive memory area based on the broadcast packet.

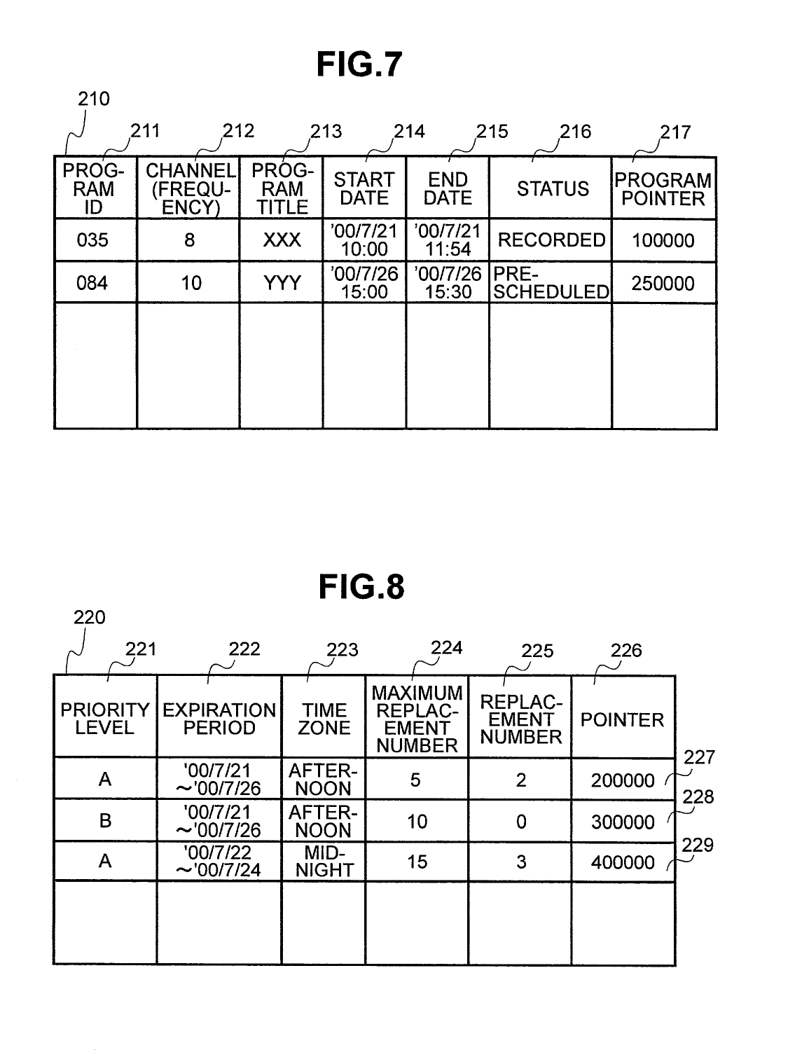

FIG. 7 shows the contents of a pre-scheduled recording list table 210. The pre-schedule program list table 210 is located in the user memory area.

In FIG. 7, the pre-schedule program list table 210 comprises a program ID (event ID) 211, a channel number (or frequency) 212, a program title 213, a start date 214, an end date 215, a status 216 and a program pointer 217.

A unique ID for a program is set in the program ID 211. Set in the channel number (or frequency) 212 is a logical channel number or a frequency for receiving the program. The title of the program is set in the program title 213. The broadcast start time and the broadcast end time of the program are respectively set in the start date 214 and the end date 215. The current state of the program in pre-schedule recording is set in the status 216. There are at least three statuses in pre-schedule recording, namely, pre-scheduled, recording and recorded. In step 110 in FIG. 6, a program whose status 216 is “pre-scheduled” is searched. The address of an area where recorded program data is stored is set in the program pointer 217. An invalid value is set in the program pointer 217 for a program whose status 216 is “pre-scheduled”.

With the contents of the program ID 211, the channel number 212, the program title 213, the start date 214, the end date 215, the status 216 and the program pointer 217 as a set (entry), the pre-schedule program list table 210 is finally constructed by zero or more entries.

The user performs an operation to record a program using an EPG (Electronic Program Guide) or the like, and the content of the operation is added to the pre-schedule program list table 210. The EPG, which has been distributed before programs are broadcast, is received by the data receiving apparatus 20 and stored in the storage unit 3 or the like.

Returning to FIG. 6, it is determined in step 110 whether the received content data is a program pre-scheduled for recording or a content distributed from a service provider. In case of digital broadcasting, the substance (video) of content data (program), program attribute information for the content and the EPG are multiplexed in the MPEG-2 format and are transmitted. The ID and channel number of the received content data are included in the program attribute information. Upon reception of content data, therefore, the contents of the pre-schedule program list table 210 are searched based on the program ID, the channel number, the current date and so forth to determine whether or not the received content data is a program pre-scheduled for recording.

When the received content data is a content distributed from a service provider, information indicating it (the aforementioned data attribute ID or the like) is stored in the program attribute information or an MPEG-2 private data area. By checking whether or not this information is present, it is determined if the received content data is a content distributed from a service provider. In case where a broadcast channel (broadcast packet) for data to be stored in the user memory area is separated from a broadcast channel (broadcast packet) data to be stored in the exclusive memory area are broadcast, it may be determined whether or not the content data should be stored in the exclusive memory area based on the broadcast channel (broadcast packet).

When it is determined in step 110 that the received content data is a content distributed from a service provider, the write control means 37 acquires the program attribute information or the service provider ID stored in the private data area and determines whether or not the service provider ID is registered in the exclusive-memory-area management table 200 (step 111). If the decision is affirmative, the received content data is stored in the storage unit 3 or the like according to the logical drive name for the service provider ID in the exclusive-memory-area management table 200 (step 112).

When it is determined in step 110 that the received content data is a program pre-scheduled for recording, the write control means 37 searches the exclusive-memory-area management table 200 to check if a user writable area is present (step 113). When a user writable area is present, the received content data is stored in the storage unit 3 or the like according to the logical drive name for the area (step 114). When a user writable area is not present in the exclusive-memory-area management table 200 or an area enough to record data is not secured, information to that effect is displayed on the output unit 7 (step 115) after which the process is terminated.

As will be discussed later, the content that is transmitted from the broadcasting provider system 15 or 16 is managed by the distribution server 13a. The distribution server 13a manages the content sent from the service provider together with the service provider ID and the content ID. The content that is transmitted from the broadcasting provider system 15 or 16 is added with the service provider ID and the content ID as attribute information. In step 111 in FIG. 6, the received content is stored in the exclusive memory area of the service provider that is specified by the service provider ID and the content ID is stored in the exclusive memory area too.

In accordance with an instruction made by the service center system 12 or a predetermined schedule, the broadcasting provider system 15 or 16 sends the data receiving apparatus 20 information indicating that the content stored in the exclusive memory area in the data receiving apparatus 20 is to be deleted. This information includes at least the service provider ID of the service provider that has provided the content to be deleted and the content ID of the content. Upon reception of the information, the data receiving apparatus 20 specifies the exclusive memory area based on the service provider ID included in the information, specifies the content based on the content ID included in the information, and deletes the content from the exclusive memory area.

The following describes the hardware structures and processes of the distribution server 13a and charge server 14a that constitute the service center system 12.

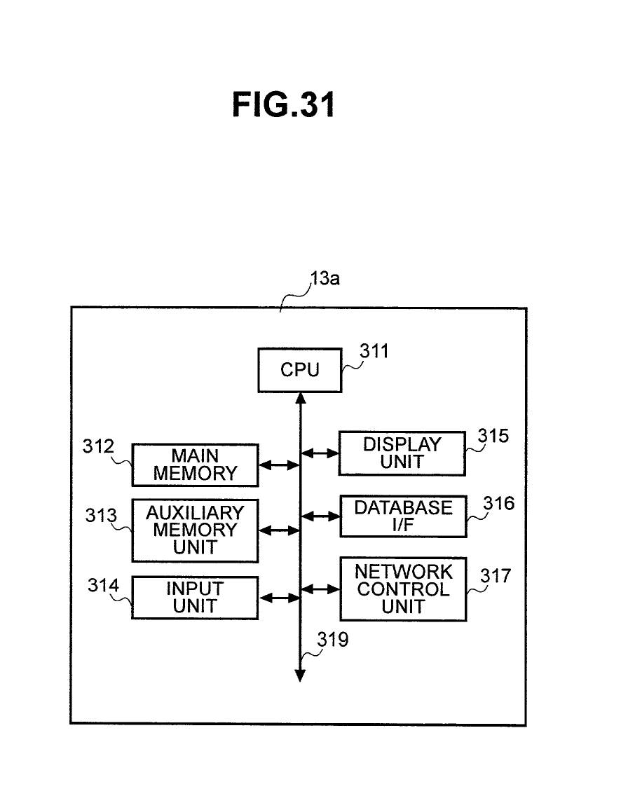

FIG. 31 presents a structural diagram of the hardware that is adapted to the distribution server 13a according to the embodiment. The distribution server 13a includes a CPU 311, a main memory 312, an auxiliary memory unit 313, an input unit 314, a display unit 315, a database interface unit 316 and a network control unit 317. The components of the distribution server 13a are connected by a bus 319 so that necessary information can be transferred among the components.

The CPU 311 executes a predetermined process according to a program previously stored in the main memory 312 or the auxiliary memory unit 313.

The main memory 312, which is means that serves as a work area or stores a necessary program, may be realized by, for example, a RAM for the former purpose and a ROM for the latter purpose.

The auxiliary memory unit 313, which is means for storing a program for controlling the operation of the distribution server 13a, may be realized by, for example, a hard disk drive or the like.

The input unit 314 is means which allows the operator of the distribution server 13a to input necessary instructions or information to the distribution server 13a. The input unit 314 is achieved by, for example, a keyboard, a mouse or the like.

The display unit 315 is means for displaying content data stored in the auxiliary memory unit 313 or the contents of the content database 13b connected via the database interface unit 316. The output unit 315 can be achieved by a CRT, liquid crystal display or the like.

The database interface unit 316 is means for connecting the content database 13b to the distribution server 13a, and is realized by an SCSI (Small Computer System Interface) adapter, a fiber channel adapter or the like. Accordingly, the CPU 311 can read and write information (data) from and in the content database 13b.

The network control unit 317 is means for exchanging information (data) over the network 23 with units that are also connected to the network 23. The network control unit 317 is realized by, for example, a modem, a network adapter, a radio transmitter/receiver or the like.

In case the components of the distribution server 13a include components which are not directly associated with the input/output of data and a program, such components can be removed from the structure shown in FIG. 31.

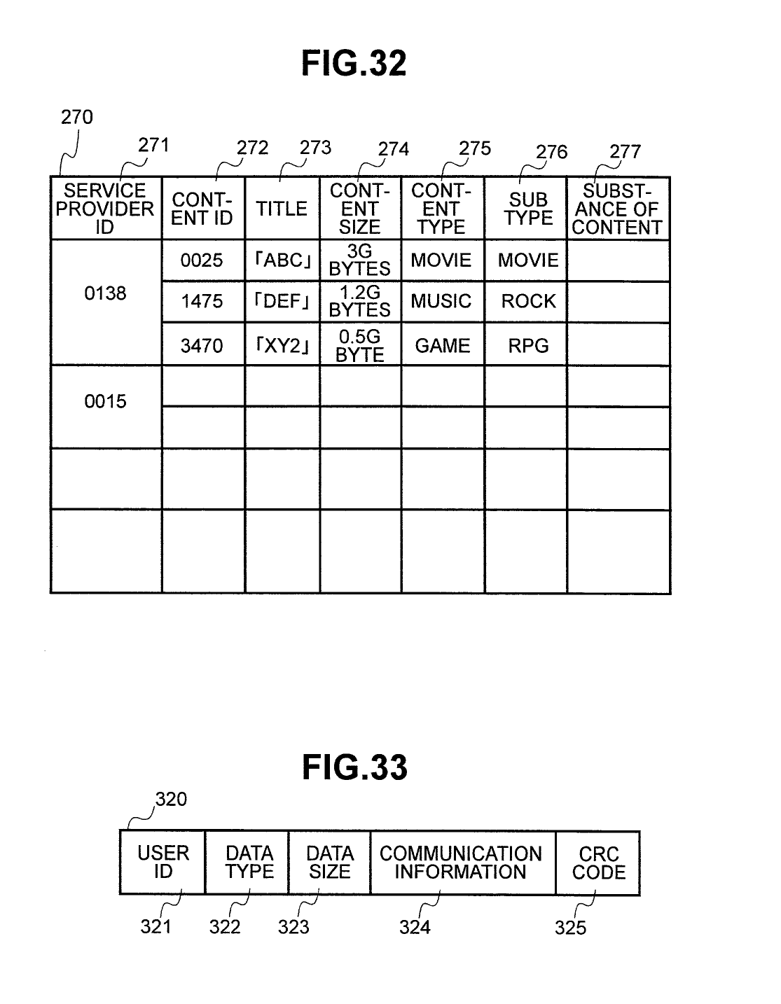

FIG. 32 shows the contents of a content management table 270 which is stored in the content database 13b and managed by the distribution server 13a.

The content management table 270 comprises a service provider ID 271, a content ID 272, a title 273, a content size 274, a content type 275, a content sub type 276 and a content's substance 277.

A unique ID which indicates the provider of the content specified by the content ID 272 is set in the service provider ID 271. It is desirable that assignment of an ID (for each service provider) that should be held by the service provider ID 271 is the same as assignment of an ID (for each service provider) that should be held by the service provider ID 201 shown in FIG. 5. That is, when the content of the service provider ID 201 shown in FIG. 5 is “0138” and the content of the service provider ID 271 is “0138”, the service provider specified by the service provider ID 201 is identical to the service provider specified by service provider ID 271.

A unique ID given to every content is set in the content ID 272.

The title of the content specified by the content ID 272 is set in the title 273.

Set in the content size 274 is the size (memory capacity or storage time duration) needed when the content specified by the content ID 272 is stored in the exclusive memory area.

Set in the content type 275 is data attribute information of the content specified by the content ID 272, such as video data, audio data or a game content.

Set in the content sub type 276 is a sub type attribute of the data specified by the content type 275. The “sub type attribute” indicates information, such as a movie, a drama or news, in case of a video data content, or information, such as rock or classic, in case of an audio data content.

Set in the content's substance 277 is the content data itself that is specified by the content ID 272.

Normally, for the content that is sent to the distribution server 13a from a service provider, the title, content type and content sub type of the content are designated as attributes and the attributes are set in the title 273, the content type 275 and the content sub type 276, respectively.

With the service provider ID 271, the content ID 272, the title 273, the content size 274, the content type 275, the content sub type 276 and the content's substance 277 as a set (entry), the content management table 270 is finally constructed by zero or more entries. There may be entries for a plurality of contents with respect to the service provider ID 271.

Content data is sent to the distribution server 13a from each service provider system via the network 23. When the distribution server 13a receives the content data sent from each service provider system, the distribution server 13a assigns a content ID to the content data and adds an entry in the content management table 270 in the content database 13b together with the ID for the service provider that has sent the content data.

The content data sent from each service provider system may be input in the distribution server 13a via a recording medium, such as DVD-ROM. In this case, the entry to be made in the content management table 270 for the content data is added as the operator of the distribution server 13a input necessary information by operating the input unit 314 based on information displayed on the display unit 315.

The contents of the content management table 270 (the necessary items among the content's substance 277, the service provider ID 271, the content ID 272, the title 273, the content size 274, the content type 275 and the content sub type 276) are distributed to the data receiving apparatus 20 via the broadcasting provider system 15 or 16.

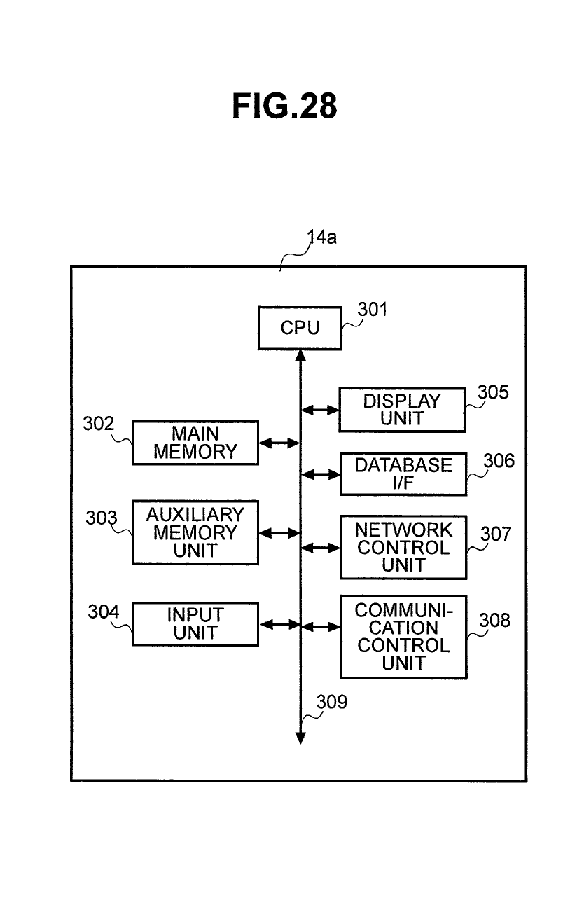

FIG. 28 presents a diagram a structural diagram of the hardware that is adapted to the charge server 14a according to the embodiment. The charge server 14a includes a CPU 301, a main memory 302, an auxiliary memory unit 303, an input unit 304, a display unit 305, a database interface unit 306, a network control unit 307 and a communication control unit 308. The components of the charge server 14a are connected by a bus 309 so that necessary information can be transferred among the components.

The CPU 301 executes a predetermined process according to a program stored beforehand in the main memory 302 or the auxiliary memory unit 303.

The main memory 302, which is means that serves as a work area or stores a necessary program, may be realized by, for example, a RAM for the former purpose and a ROM for the latter purpose.

The auxiliary memory unit 303 is means for storing a program for controlling the operation of the charge server 14a. The auxiliary memory unit 303 may be realized by, for example, a hard disk drive or the like.

The input unit 304 is means which allows the operator of the charge server 14a to input necessary instructions or information to the charge server 14a. The input unit 304 is achieved by, for example, a keyboard, a mouse or the like.

The display unit 305 is means for displaying content data stored in the auxiliary memory unit 303 or the contents of the client database 14b connected via the database interface unit 306. The output unit 305 can be achieved by a CRT, liquid crystal display or the like.

The database interface unit 306 is means for connecting the client database 14b to the charge server 14a, and is realized by an SCSI adapter, a fiber channel adapter or the like. Accordingly, the CPU 301 can read and write information (data) from and in the client database 14b.

The network control unit 307 is means for exchanging information (data) over the network 23 with units that are also connected to the network 23. The network control unit 307 is realized by, for example, a modem, a network adapter, a radio transmitter/receiver or the like.

The communication control unit 308 is means for exchanging information (data) with the data receiving apparatus 20 over the network 23. The communication control unit 308 is realized by, for example, a modem, a network adapter, a radio transmitter/receiver or the like. In case the network 21 is the same as the network 23, the network control unit 307 is the same as the communication control unit 308 so that the charge server 14a should be equipped with at least one of the network control unit 307 is the same as the communication control unit 308.

In case the components of the charge server 14a include components which are not directly associated with the input/output of data and a program, such components can be removed from the structure shown in FIG. 28.

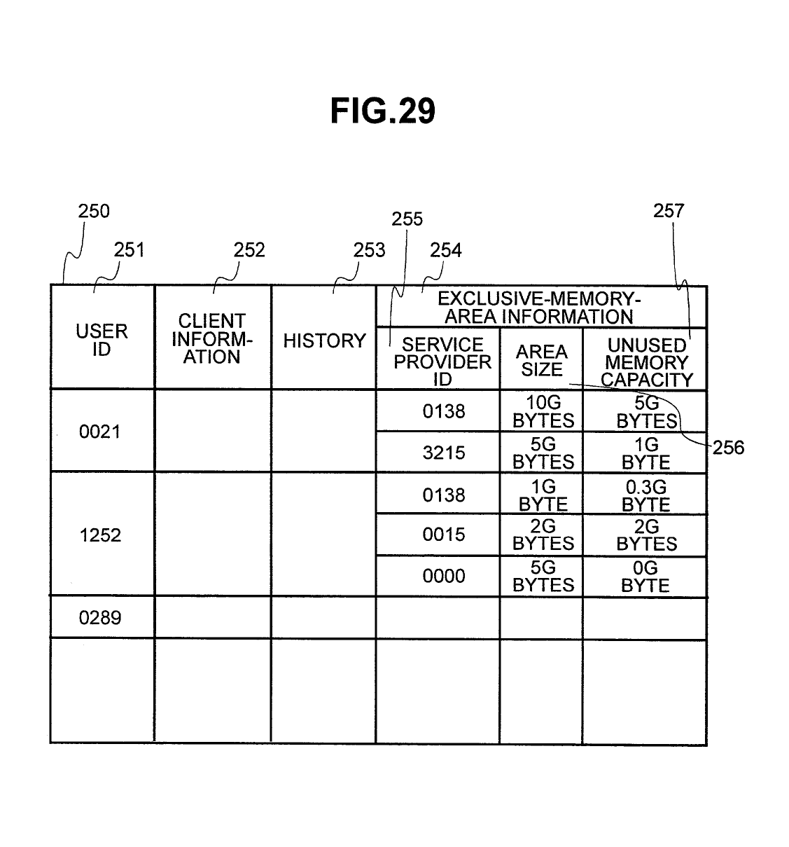

FIG. 29 shows the contents of a client information management table 250 which is stored in the client database 14b and managed by the charge server 14a.

The client information management table 250 comprises a user ID 251, client information 252, a history 253 and an exclusive-memory-area information 254.

A unique ID given to the user of the data receiving apparatus 20 is set in the user ID 251. It is desirable that the ID has been set in the data receiving apparatus 20 beforehand at the time the user buys (acquires) the data receiving apparatus 20. In case where the data receiving apparatus 20 has an IC card slot through which an IC card is installable or detachable, though not illustrated in FIG. 2, and the IC card is sold together with the data receiving apparatus 20, the ID may be set in the IC card.

Set in the client information 252 is user attribute information, such as the address, age, sex, place of contact and occupation. It is desirable that the attribute information should be notified to the operator of the service center system 12 via a post card, facsimile or the like or electric data representing the attribute information should be electronically notified to the charge server 14a via the network 21, after the user acquires the data receiving apparatus 20. In case of sending electric data, it is desirable that the data receiving apparatus 20 should display a screen prompting an input of the attribute information on the display unit 7 by an operation made by the user and automatically send the attribute information to the charge server 14a by an operation made by the user after the user has input the attribute information.

Set in the history 253 are the reception history, recording history and viewing history (reproduction history) of data and so forth which represents such actions made by the user who is specified by the user ID 251.

Set in the exclusive-memory-area information 254 is information about the exclusive memory area secured in the storage unit 3 of the data receiving apparatus 20 that is owned by the user specified by the user ID 251. The exclusive-memory-area information 254 further has three entries, a service provider ID 255, an entire memory capacity or entire storage time duration 256 of the area and an unused memory capacity or remaining storage time 257.

Set in the service provider ID 255 is a unique ID given to every service provider which provides the data receiving apparatus 20 with a service (such as information or a content). Set in the entire memory capacity or entire storage time duration 256 is the total capacity (entire memory capacity or entire storage time duration) of the exclusive memory area for the service provider indicated by the service provider ID 255 (or secured in the storage unit 3 of the data receiving apparatus 20). Set in the unused memory capacity or remaining storage time 257 is that memory capacity or remaining storage time in the entire memory capacity or entire storage time duration indicated by the entire memory capacity or entire storage time duration in or over which data to be transmitted newly can be stored. The unused memory capacity or remaining storage time 257 may be a used memory capacity or memory-used time. In this case, a value obtained by subtracting the unused memory capacity or remaining storage time from the entire memory capacity or entire storage time duration of the area that is indicated by the entire memory capacity or entire storage time duration 256 is set the used memory capacity or memory-used time 257.

With the contents of the user ID 251, the client information 252, the history 253, the service provider ID 255, the entire memory capacity or entire storage time duration 256 and the unused memory capacity or remaining storage time 257 as a set (entry), the exclusive-memory-area management table 200 is finally constructed by zero or more entries.

There may be plural pieces of exclusive-memory-area information 254 with respect to a single user ID 251. In this case, a plurality of exclusive memory areas for service providers are secured in one data receiving apparatus 20. In case where there is no exclusive memory area secured in the data receiving apparatus 20, information indicating that there is no exclusive memory area secured is set in the service provider ID 255 of the exclusive-memory-area information 254 that belongs to the same entry as the user ID 251 of the data receiving apparatus.

In the example illustrated in FIG. 29, the user with the user ID of “0021” has secured, in the data receiving apparatus 20 owned by the user, two exclusive memory area for two service providers that are respectively specified by the service provider IDs of “0138” and “3215”. Likewise, the user with the user ID of “1252” has secured, in the data receiving apparatus 20 owned by the user, three exclusive memory area for three service providers that are respectively specified by the service provider IDs of “0138”, “0015” and “3215”. For the user with the user ID of “0289”, no exclusive memory area is secured for any service provider and information indicating such (e.g., “0000”) is set in the service provider ID 255.

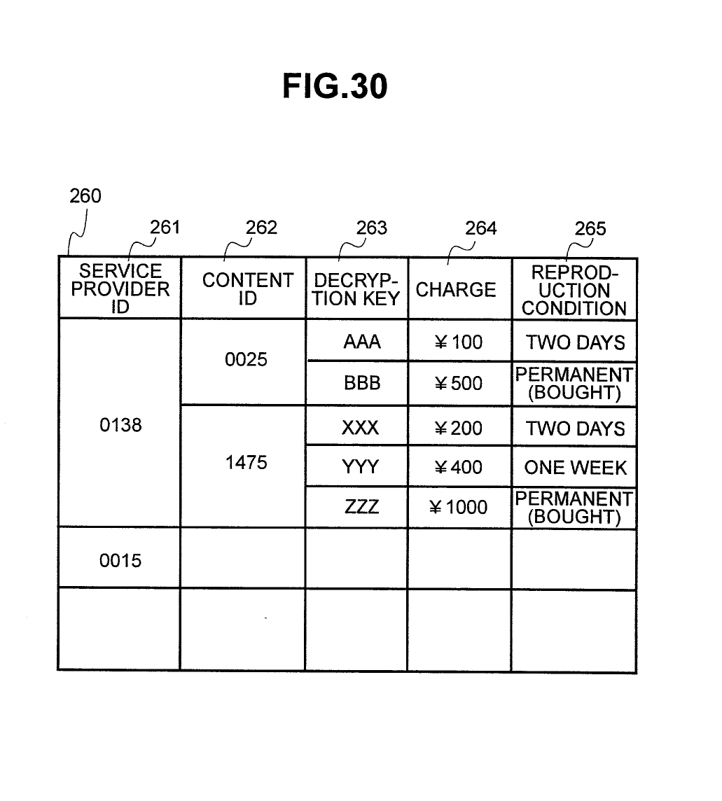

FIG. 30 shows the contents of a charge information management table 260 which is stored in the client database 14b and managed by the charge server 14a.

The charge information management table 260 comprises a service provider ID 261, a content ID 262, a decryption key 263, a charge 264 and a reproduction condition 265.

A unique ID indicating the provider (service provider) of the content specified by the content ID 262 is set in the service provider ID 261.

Set in the content ID 262 is a unique ID given to every content. The contents of the service provider ID 261 and the content ID 262 are transmitted from the distribution server 13a over the network 23.

When content data is distributed to the data receiving apparatus 20 from the broadcasting provider system 15 or 16, some sort of encryption is preformed in order to prevent unauthorized copying. A decryption key for decoding the encrypted content is set in the decryption key 263. The distribution server 13a or the charge server 14a performs the encrypting process. When the distribution server 13a performs the encrypting process, the decryption key is sent to the charge server 14a over the network 23.

The charge (money) of the content specified by the content ID 262 and the then reproduction condition are respectively set in the charge 264 and the reproduction condition 265. The reproduction condition indicates, for example, the number of days (or hours), such as two days, one week and permanent (bought), over which reproduction is possible. In case where the user of the data receiving apparatus 20 purchased the received content under the reproduction condition of two days, the user can view (reproduce) the content for two days since the point of purchase. The number of reproductions or the number of copies or the like may be designated as the reproduction condition.

With the contents of the service provider ID 261, the content ID 262, the decryption key 263, the charge 264 and the reproduction condition 265 as a set (entry), the charge information management table 260 is finally constructed by zero or more entries.

A plurality of content IDs 262, decryption keys 263, charges 264 and reproduction conditions 265 may be provided for a single service provider ID 261. A plurality of decryption keys 263, charges 264 and reproduction conditions 265 may be provided for a single content ID 262.

In the example illustrated in FIG. 30, for the content with the content ID of “0025”, the charge (the money that the user who has bought the content should pay) is 100 yen under the reproduction condition of “two days” and is 500 yen under the reproduction condition of “permanent (bought)”. The purchase of a content by a user means purchase of a decryption key (the content of the decryption key 263 in the charge information management table 260) for decoding an encrypted content. The decryption key the user bought is sent to the data receiving apparatus 20 over the network 21 from the charge server 14a. The decryption key for decoding an encrypted content may be transmitted together with the content from the broadcasting provider system 15 or 16 and stored in the storage unit 3 of the data receiving apparatus 20.

The data receiving apparatus 20 communicates with the charge server 14a over the network 21 in accordance with some event. The contents to be communicated are, for example, information on the securing/deletion of the exclusive memory area, information on the entire memory capacity (or entire storage time duration), used memory capacity (or memory-used time duration) or unused memory capacity (or remaining storage time duration) of the exclusive memory area, client information, history information, such as the data reception history, recoding history and view history, and information about the purchase of the content. It is desirable that the information which is transmitted from the data receiving apparatus 20 should have been encrypted.

FIG. 33 shows a data structure 320 of information to be transmitted to the charge server 14a from the data receiving apparatus 20. The data structure 320 comprises a combination of a user ID 321, a data type 322, a data size 323, communication information 324 and a CRC 325, and is formed by the data receiving apparatus 20.

The user ID 321 is the unique ID that is given to the user of the data receiving apparatus 20 and has been discussed with reference to FIG. 29.

The data type 322 is an identifier for identifying the mentioned information on the securing/deletion of the exclusive memory area, information on the entire memory capacity (or entire storage time duration), used memory capacity (or memory-used time duration) or unused memory capacity (or remaining storage time duration) of the exclusive memory area, client information, history information, such as the data reception history, recoding history and view history, information about the purchase of the content or the like.

The data size 323 is the total amount of data of the communication information 324 and the CRC 325 that follow the data size 323.

The communication information 324 is the mentioned information on the securing/deletion of the exclusive memory area, information on the entire memory capacity (or entire storage time duration), used memory capacity (or memory-used time duration) or unused memory capacity (or remaining storage time duration) of the exclusive memory area, client information, history information, such as the data reception history, recoding history and view history, or information about the purchase of the content or the like itself.

The CRC 325 is a CRC (Cyclic Redundancy Check) code for checking if every transmitted data has been transmitted completely.

The following discusses the process of the charge server 14a associated with the communication between the data receiving apparatus 20 and the charge server 14a.

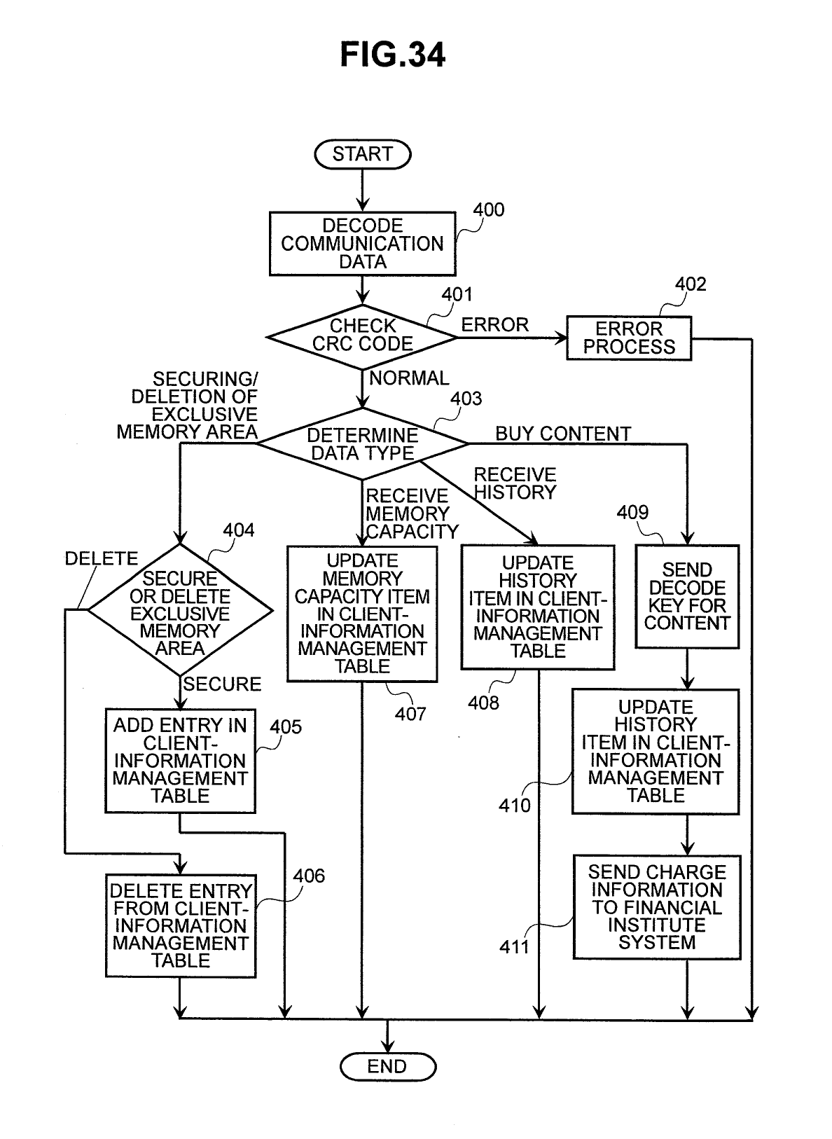

FIG. 34 shows a process flowchart of communication data processing means which accomplishes the process of the charge server 14a associated with the communication. The communication data processing means is one of software programs that operate on the charge server 14a, which is stored in the main memory 302 or the auxiliary memory unit 303 and executed by the CPU 301 when the communication control unit 308 receives communication data.

As shown in FIG. 34, the communication data processing means first decodes information (having a structure indicated by the data structure 320 and encrypted) sent from the data receiving apparatus 20 (step 400), and checks the CRC 325 (step 401). When detecting that normal reception has failed based on the check result, the communication data processing means executes an error process (a process which makes a resend request or notifies the failure of normal reception to the sender) (step 402). In case of making the resend request, the communication data processing means wits for reception of resent data, then returns the process to step 400.

When the check result in step 401 indicates that normal reception has been made, the communication data processing means determine the data type of the received information from the content of the data type 322 (step 403).

When the data type of the received information is information on the securing/deletion of the exclusive memory area, the communication information 324 includes information on the securing/deletion of the exclusive memory area and information indicating the securing/deletion of the exclusive memory area, included in that information is then checked (step 404). When it is determined here that the received information is information indicating the securing of the exclusive memory area, IDS held by the individual user IDs 251 in the client information management table 250 are searched based on the ID held by the user ID 321, an exclusive-memory-area information 254 is newly provided in the entry which has a matched ID and values are set in the service provider ID 255 and the area size 256 in the newly provided exclusive-memory-area information 254 (step 405). The service provider ID and the area size are included in the communication information 324. When there is the exclusive-memory-area information 254 whose service provider ID 255 is “0000”, the exclusive-memory-area information is deleted. When an entry which has the ID held by the user ID 321 is not preset in the client information management table 250, an entry with the ID is to be provided newly.

When the received information is determined as information indicating the deletion of the exclusive memory area in step 404, IDs held by the individual user IDs 251 in the client information management table 250 are searched based on the ID held by the user ID 321, and the exclusive-memory-area information 254 which coincides with the service provider ID included in the communication information 324 is deleted from the entry which has a matched ID (step 406). When there is no exclusive-memory-area information 254 present in the matched which has the matched ID as a result of the deletion, an exclusive-memory-area information 254 whose service provider ID 255 is “0000” is newly provided.

When the data type of the received information is information on the entire memory capacity (or entire storage time duration), used memory capacity (or memory-used time duration) or unused memory capacity (or remaining storage time duration) of the exclusive memory area in step 403, the communication information 324 includes at least one of information on the entire memory capacity (or entire storage time duration), used memory capacity (or memory-used time duration) or unused memory capacity (or remaining storage time duration) of the exclusive memory area. Here, based on the ID held by the user ID 321, IDs held by the individual user IDs 251 in the client information management table 250 are searched for an entry which has a matched ID. Further, the exclusive-memory-area information 254 which coincides with the ID held by the service provider ID is further searched with respect to the matched entry, and the value of information on the entire memory capacity (the content of the entire memory capacity or entire storage time duration 256), the used memory capacity or the unused memory capacity (the content of the unused memory capacity or remaining storage time 257) is updated with respect to the matched exclusive-memory-area information 254 (step 407).

When the data type of the received information is client information or history information, such as the data reception history, recoding history and view history, in step 403, IDs held by the individual user IDs 251 in the client information management table 250 are searched based on the ID held by the user ID 321, and the contents of the client information 252 and history 253 of the entry which has a matched ID are updated (step 408).

When the data type of the received information is information about the purchase of the content in step 403, the communication information 324 includes the ID and the reproduction condition of the content to be bought. Here, based on the ID held by the user ID 321, IDs held by the individual user IDs 251 in the client information management table 250 are searched for an entry which has a matched ID. With respect to the matched entry, the decryption key (the content of the decryption key 263) and the charge (the content of the charge 264) that coincide with the reproduction condition are acquired, and the decryption key is transmitted to the data receiving apparatus 20 which has transmitted the information (step 409). Further, IDs held by the individual user IDs 251 in the client information management table 250 are searched based on the ID held by the user ID 321, and the content of the history 253 of the entry that has the matched ID is updated (step 410). Further, the user ID and the charge are transmitted to the financial institute system 22 (step 411). Finally, the financial institute system 22 makes a charge. The service center system 12 may execute the charging process in place of the financial institute system 22.

The contents that are managed by the charge information management table 260 are distributed in accordance with a distribution schedule. While the distribution schedule is made in view of the wishes of the service provider or service center which provides contents, the distribution schedule can be prepared for each user based on at least one of the client information 252, the history 253 and the unused memory capacity or remaining storage time 257 in the client information management table 250. The latter case can ensure the content distribution that improves each user's intention to buy a content. As the service center system 12 transmits the distribution schedule in the form of an EPG or the like to the data receiving apparatus 20 from the broadcasting provider system 15 or 16 beforehand, the user can known the distribution schedule in advance.

Referring to the accompanying drawings, the operation of the embodiment is described below with reference to a case where content data to be distributed from a service provider is a commercial (CM) or the like.

To begin with, as a first embodiment, a CM replacement scheme is discussed.

In the first embodiment, the service provider system 10 or 11 or the service center system 12 distributes CM data based on a certain strategy. CM data may be broadcast from the broadcasting provider system 15 or 16 or may be transmitted from the network 21. When received by the data receiving apparatus 20, the CM data is not displayed on the output unit 7 in real time, but is stored in the storage unit 3 according to the contents of the exclusive-memory-area management table 200. When the user views (displays) a recorded program including CM data, the CM in the program is replaced with the CM previously distributed and stored in the storage unit 3 under a certain condition. When a CM is not inserted in a program, new CM data may be inserted in program data.

CM data to be distributed in advance is accompanied with attribute information. The attribute information stored in the storage unit 3 is managed by a CM data management table 220. The CM data management table 220 should not necessarily be located in the exclusive memory area.

FIG. 8 shows the contents of the CM data management table 220. Referring to FIG. 8, the CM data management table 220 comprises a priority level 221, an expiration period 222, a time zone 223, a maximum replacement number 224, a replacement number 225 and a pointer 226.

The contents of the CM data management table 220 are set by the service provider or broadcasting provider. CM data is displayed on the output unit 7 in linkage with program data.

Set in the priority level 221 is a replacement priority level that is used to determine which CM data is to be replaced when there is CM data to be replaced under the same conditions. Set in the expiration period 222 is a date range over which CM data is replaceable. CM data whose expiration period is over is automatically deleted from the CM data management table 220 and the CM data itself is deleted from the storage unit 3. Set in the time zone 223 is a time zone in which CM data is replaceable and insertable within the expiration period. The time zone can be expressed in terms of a range, such as morning, afternoon, night or midnight, or in terms of a time, such as hours, minutes and seconds. The number of times replacement can be made is set in the maximum replacement number 224. The number of times CM data has been replaced and inserted is set in the replacement number 225. The CM data whose replacement number reaches the number specified by the maximum replacement number 224 is automatically deleted from the CM data management table 220 and the CM data itself is deleted from the storage unit 3. Set in the pointer 226 is the address of an area where CM data itself is stored.

With the contents of the priority level 221, the expiration period 222, the time zone 223, the maximum replacement number 224, the replacement number 225 and the pointer 226 as a set (entry), the CM data management table 220 is finally constructed by zero or more entries. In the example illustrated in FIG. 8, an entry 227 and an entry 228 have the same replacement conditions (the expiration period and the time zone) but have different priority levels (the priority level of the entry 227 is higher) . When CM data is to be replaced under the matched conditions, the entry 227 is selected and is inserted for replacement.

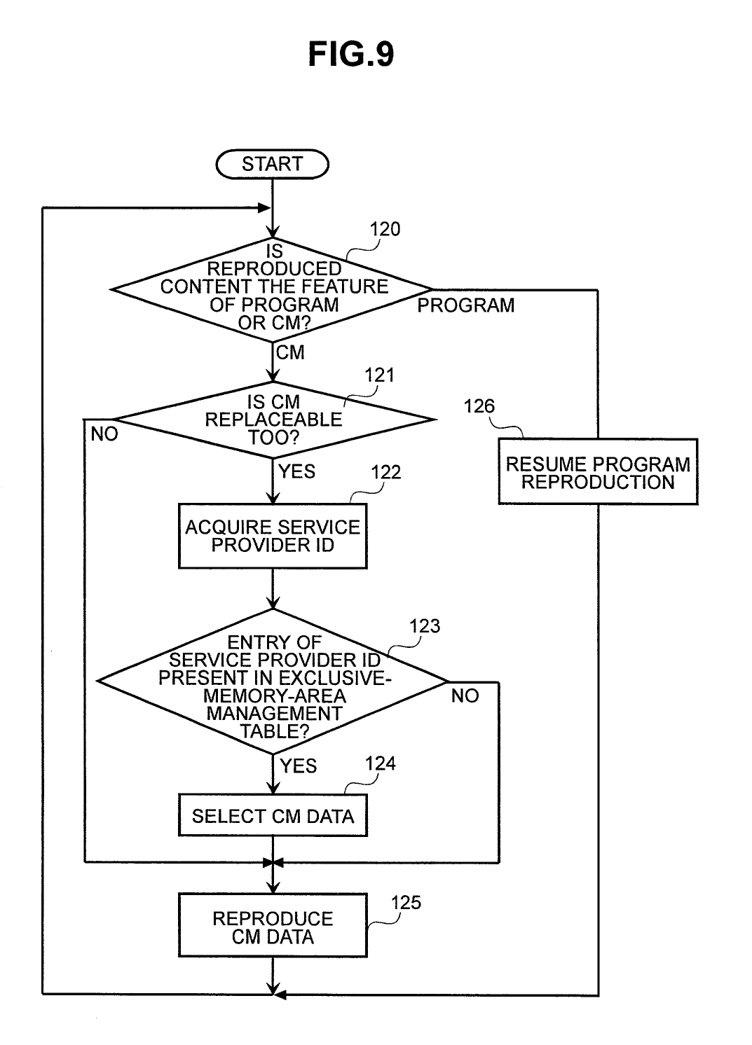

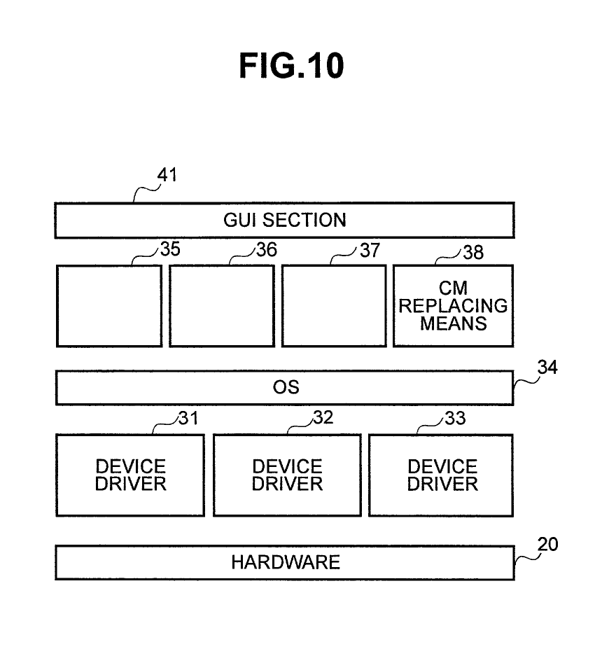

FIG. 9 illustrates a process flowchart of CM replacing means 38. The CM replacing means 38 is one of software programs which run on the data receiving apparatus 20 and has a software structure as shown in FIG. 10, which runs on the data receiving apparatus 20.

The CM replacing means 38 is activated when a recorded program is reproduced. The CM replacing means 38 may be activated in accordance with a predetermined schedule, or when the expiration period of CM data inserted in the program has passed, or when the expiration period of CM data stored in the storage unit 3 has passed.

As shown in FIG. 9, the CM replacing means 38 determines whether a content (the general term for the main part or feature of a program and a CM) whose reproduction is currently in progress is the feature of the program (main data) or CM (sub data) (step 120). Normally, a CM is inserted before, after or in a middle of a program to be broadcast. In the CM, information indicating a CM, a service provider ID indicating which service provider has provided the CM and information indicating if the CM is replaceable are included in program attribute information to be distributed (broadcast) at the same time or an MPEG-2 private area. In step 120, the information that indicates the CM data is acquired to make a decision.

When it is determined that the content is CM data, the information that indicates whether or not the CM data is replaceable is acquired from the program attribute information or the private data area (step 121). When the CM data is replaceable, the service provider ID that indicates which service provider has provided the CM data is obtained from the program attribute information or the private data area (step 122).

Next, the CM replacing means 38 searches the exclusive-memory-area management table 200 for an exclusive memory area secured for a service provider corresponding to the service provider ID (step 123). When the exclusive memory area is secured, the CM replacing means 38 selects CM data to be replaced from the contents of the CM data management table 220 stored in the exclusive memory area (step 124). The CM replacing means 38 then loads the selected CM data by referring to the pointer 226 in the CM data management table 220 and reproduces the CM data (step 125). Then, the CM replacing means 38 returns to step 120 and repeats the process until reproduction of the program is finished.

When the CM data is not replaceable in step 121, when an exclusive memory area for a service provider which corresponds to the service provider ID is not secured in step 123, and when there is no replaceable and insertable CM data in step 124, the original CM data is reproduced.

When the reproduced content is not a CM in step 120, program reproduction continues (step 126), then the CM replacing means 38 returns to step 120 and repeats the process until program reproduction is completed.

According to the CM replacing scheme of the first embodiment, as apparent from the above, an exclusive memory area for a service provider is secured in the storage unit of the data receiving apparatus, the service provider distributes CM data based on a plan (strategy) and stores it in the exclusive memory area, and a CM can be reproduced timely at the time of time-shift viewing (reproduction while recording) of a program. It is therefore possible to provide a user with a reliable and flexible service or information.

In the first embodiment, an exclusive memory area for a service provider is secure in the storage unit of the data receiving apparatus and is completely separated from other memory areas. When the storage unit is an HDD, for example, a logical drive name for accessing to the exclusive memory area differs from a logical drive for accessing to other memory areas.

A description will now be given of a method according to a second embodiment which uses the same logical drive name to access both the exclusive memory area and other memory areas. The method of the second embodiment does not assign a logical drive to each of exclusive memory areas of individual service providers, but manages plural exclusive memory areas for service providers and a user memory area with, for example, a single logical drive.

While an exclusive memory area for a service provider is managed by the exclusive-memory-area management table 200 shown in FIG. 5 in the first embodiment, it is managed by using an exclusive-memory-area management table 240 shown in FIG. 15 in the second embodiment.

Referring to FIG. 15, the exclusive-memory-area management table 240 comprises a service provider ID 241, an area size (memory capacity or storage time duration) 242, and an available area size (available memory capacity or available storage time duration) 243.

The service provider ID 241 and the area size 242 are the same as the service provider ID 201 and the area size 202 shown in FIG. 5.

The available area size 243 holds a value obtained by subtracting, from the content of the area size 242, the sum of the capacities (sizes) of the contents actually distributed by the service providers indicated by the service provider ID 241. That is, the available area size 243 indicates the remaining size that can be freely used by the service providers. The available area size 243 may be the sum of the capacities (unused capacities) of the contents actually distributed by the service providers indicated by the service provider ID 241.

The capacity of the memory area that is used by the user (for recording a program or the like 9 becomes a size resulting from subtracting the sum of the sizes of memory areas secured for service providers (the content of the area size 242 in the exclusive-memory-area management table 240) from the entire memory capacity provided by the storage unit, and an entry for the memory area writable only by the user (viewer) shown in FIG. 5 should not necessarily be located in the exclusive-memory-area management table 240.

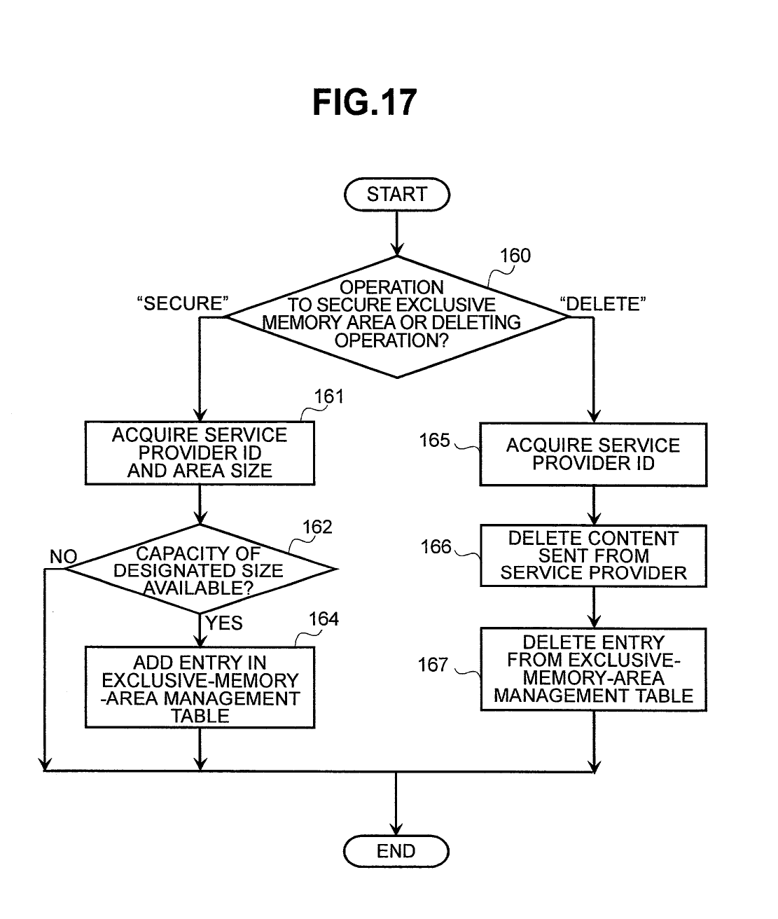

FIG. 17 illustrates a process flowchart of the exclusive-memory-area managing means 36 in the second embodiment.

The exclusive-memory-area managing means 36 is activated when the SECURE button 510 on the screen in FIG. 27 displayed by the GUI section 41 is specified or when the DELETE button 506 on the screen in FIG. 26 displayed by the GUI section 41 is specified.

As shown in FIG. 17, the exclusive-memory-area managing means 36 first determines whether or not it is a memory-area securing operation or a memory-area deleting operation (step 160). When the operation is the memory-area securing operation (when the SECURE button 505 is specified), the exclusive-memory-area managing means 36 acquires the content of the service provider name or service provider ID 501 and the content of the memory capacity or storage time duration 508 (step 161). The exclusive-memory-area managing means 36 then determines whether or not it is possible to secure in the storage unit 3 an area corresponding to the memory capacity or storage time duration for the exclusive memory area to be secured (step 162). When such is not possible (when there is no area remained in the storage unit 3 to secure the exclusive memory area), the exclusive-memory-area managing means 36 prompts the user to make an input again. When the area size is usable as an available area in the storage unit 3 in step 162, an entry for the area is added to the exclusive-memory-area management table 240 (step 164) after which the process is terminated.

When the user's operation is “DELETE” in step 160, the exclusive-memory-area managing means 36 further acquires the service provider name or service provider ID (identifier) input by the user (step 165). Then, the content that has already been distributed by the service provider indicated by the ID (in case of the service provider name, the name is converted to a service provider ID) and stored is deleted (step 166).

Then, the exclusive-memory-area managing means 36 deletes the entry for the service provider ID to be deleted from the exclusive-memory-area management table 240 (step 167), and terminates the process.

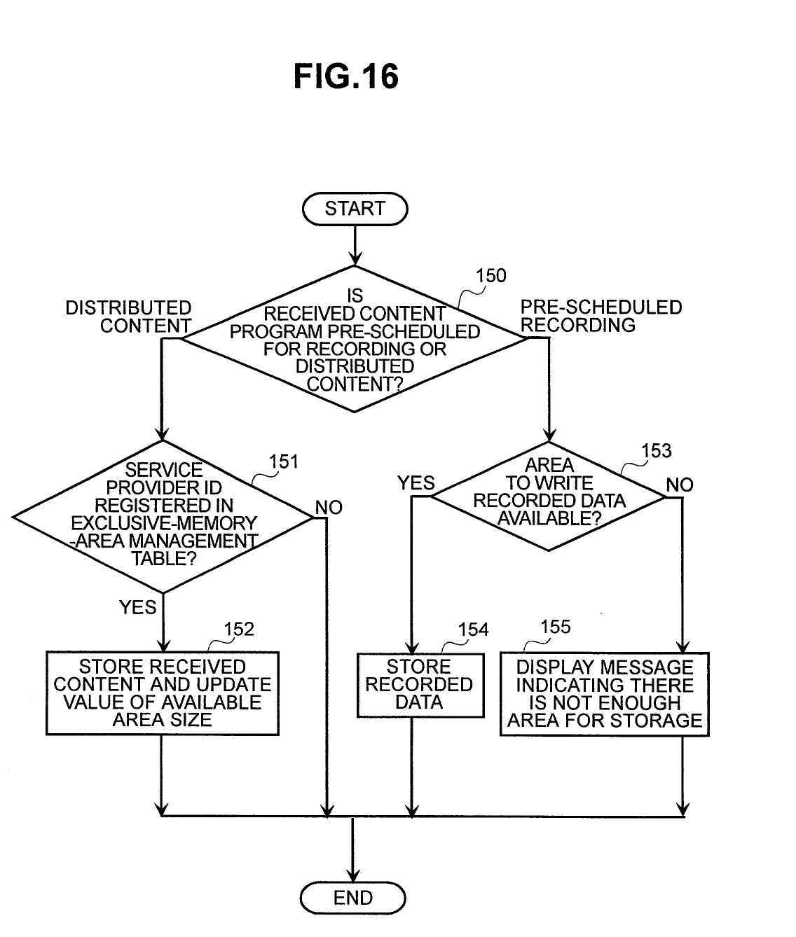

FIG. 16 illustrates a process flowchart of the write control means 37 in the second embodiment.

As shown in FIG. 16, the write control means 37 first determines whether the received content data is broadcast program data pre-scheduled for recording or a content distributed from a service provider (step 150). Pre-scheduled recording information is prestored in the storage unit 3 as the pre-scheduled recording list table 210. The write control means 37 determines whether or not the received content is a program pre-scheduled for recording by checking if the received content is described in the pre-schedule program list table 210.

It is determined in step 150 whether the received content is a program pre-scheduled for recording or a content distributed from a service provider. In case of digital broadcasting, the substance (video) of content data (program), program attribute information for the content and the EPG are multiplexed in the MPEG-2 format and are transmitted. The ID and channel number of the received content data are included in the program attribute information. Upon reception of content data, therefore, the contents of the pre-schedule program list table 210 are searched based on the program ID, the channel number, the current date and so forth to determine whether or not the received content data is a program pre-scheduled for recording.

When the received content data is a content distributed from a service provider, information indicating it is stored in the program attribute information or an MPEG-2 private data area. By checking whether or not this information is present, it is determined if the received content data is a content distributed from a service provider.

When it is determined in step 150 that the received content is a content distributed from a service provider, the write control means 37 acquires the program attribute information or the service provider ID stored in the private data area and determines whether or not the service provider ID is registered in the exclusive-memory-area management table 240 (step 151). If the decision is affirmative, the received content is stored in the storage unit 3 or the like and a value obtained by subtracting the size of the stored content from the content of the available area size 243 in the exclusive-memory-area management table 240 for the service provider ID is set newly in the available area size 243 (step 152). When it is determined in step 150 that the received content is a program pre-scheduled for recording, the available area sizes of all the exclusive memory areas for service providers registered in the exclusive-memory-area management table 240 are added and it is determined whether or not a value obtained by subtracting the added value from the entire available area size of the storage unit 3 (a value obtained by subtracting the actually used capacity from the entire capacity of the storage unit 3) is larger than the size of the content (step 153). When the former value is larger than the latter one, it is determined the received content can be stored and the received content is stored in the storage unit 3 or the like (step 154). When there is not an enough area to store the content in step 153, information indicating such is displayed on the output unit 7 (step 155) after which the process is terminated.

According to the second embodiment, as apparent from the above, as an area large enough to store a content to be distributed by a service provider (via a broadcasting provider) is always pooled in the storage unit 3, a plurality of exclusive memory areas for plural service providers can be secured using a single logical drive name. In the first and second embodiments, write control to the exclusive memory area is executed using the exclusive-memory-area management table 200 or 240.

The following describes a write control method according to a third embodiment, which controls writing to an exclusive memory area without using the exclusive-memory-area management table 200 or 240.

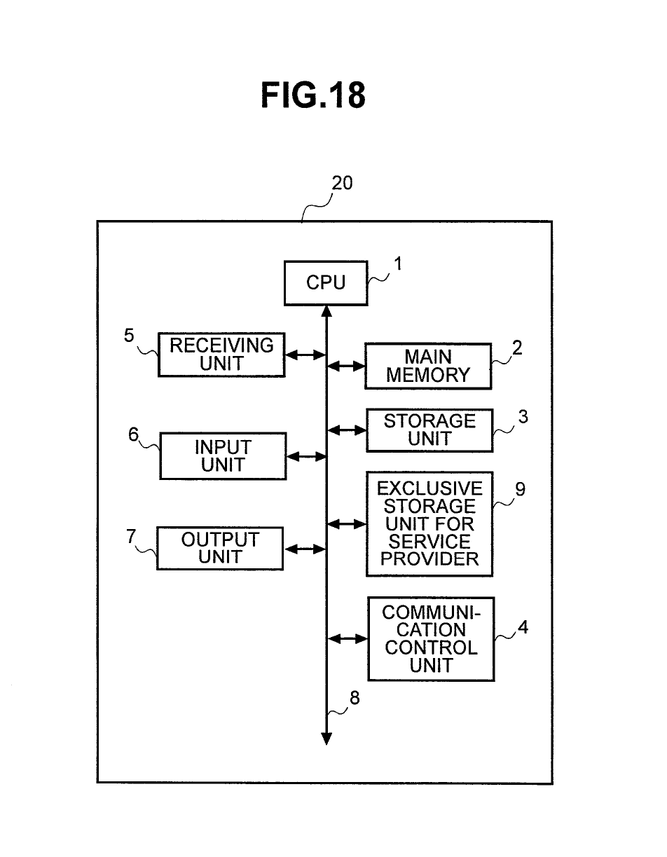

FIG. 18 shows a hardware structural diagram of the data receiving apparatus 20 to which the third embodiment can be adapted.

As shown in FIG. 18, the data receiving apparatus 20 comprises a CPU 1, a main memory 2, a storage unit 3, a communication control unit 4, a receiving unit 5, an input unit 6, an output unit 7 and an exclusive storage unit 9 for a service provider. The individual components of the data receiving apparatus 20 are connected together by the bus 8 so that necessary information can be transferred among the individual components.

The CPU 1, the main memory 2, the storage unit 3, the communication control unit 4, the receiving unit 5, the input unit 6 and the output unit 7 are the same as those shown in FIG. 2, respectively.

While the storage unit 3 in FIG. 2 is means one of whose purposes is to store a content provided by a service provider and broadcast (distributed) by a broadcasting provider, the storage unit 3 in FIG. 18 does not store a content provided by a service provider and broadcast (distributed) by a broadcasting provider.

The exclusive storage unit 9 is means for storing a content provided by a service provider and broadcast (distributed) by a broadcasting provider, and is realized by, for example, a hard disk (HDD), an optical disk or the like. The hard disk may be designed to be detachably attachable to the data receiving apparatus 20. A plurality of exclusive storage units 9 for service providers may be connectable to the data receiving apparatus.

That is, an exclusive memory area for a service provider is stored in the exclusive storage unit 9.

In case where the components of the data receiving apparatus 20 include components which are not directly associated with the input/output of data and a program, such components can be removed from the structure shown in FIG. 18.

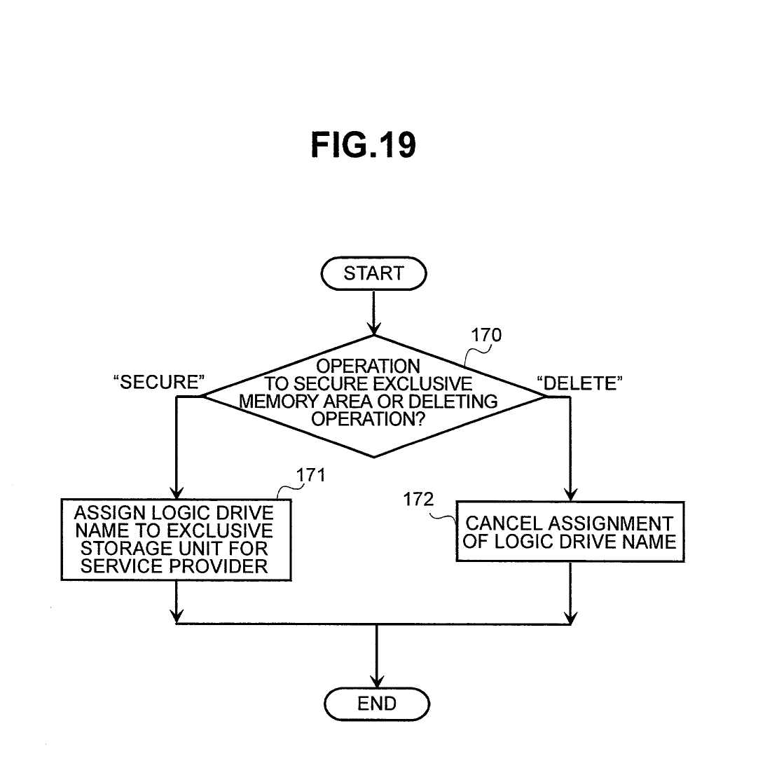

FIG. 19 illustrates a process flowchart of the exclusive-memory-area managing means 36 in the third embodiment.

The exclusive-memory-area managing means 36 is activated when the SECURE button 510 on the screen in FIG. 27 displayed by the GUI section 41 is specified or when the DELETE button 506 on the screen in FIG. 26 displayed by the GUI section 41 is specified.

As shown in FIG. 19, the exclusive-memory-area managing means 36 first determines whether or not it is a memory-area securing operation or a memory-area deleting operation (step 170). When the operation is the memory-area securing operation (when the SECURE button 505 is specified), the exclusive-memory-area managing means 36 assigns a logical drive name to the exclusive storage unit 9 connected to the data receiving apparatus 20 (step 171) after which the process is terminated.

When the user's operation is “DELETE” in step 170, the assignment of the logical drive name to the exclusive storage unit 9 is canceled (step 172) after which the process is terminated.

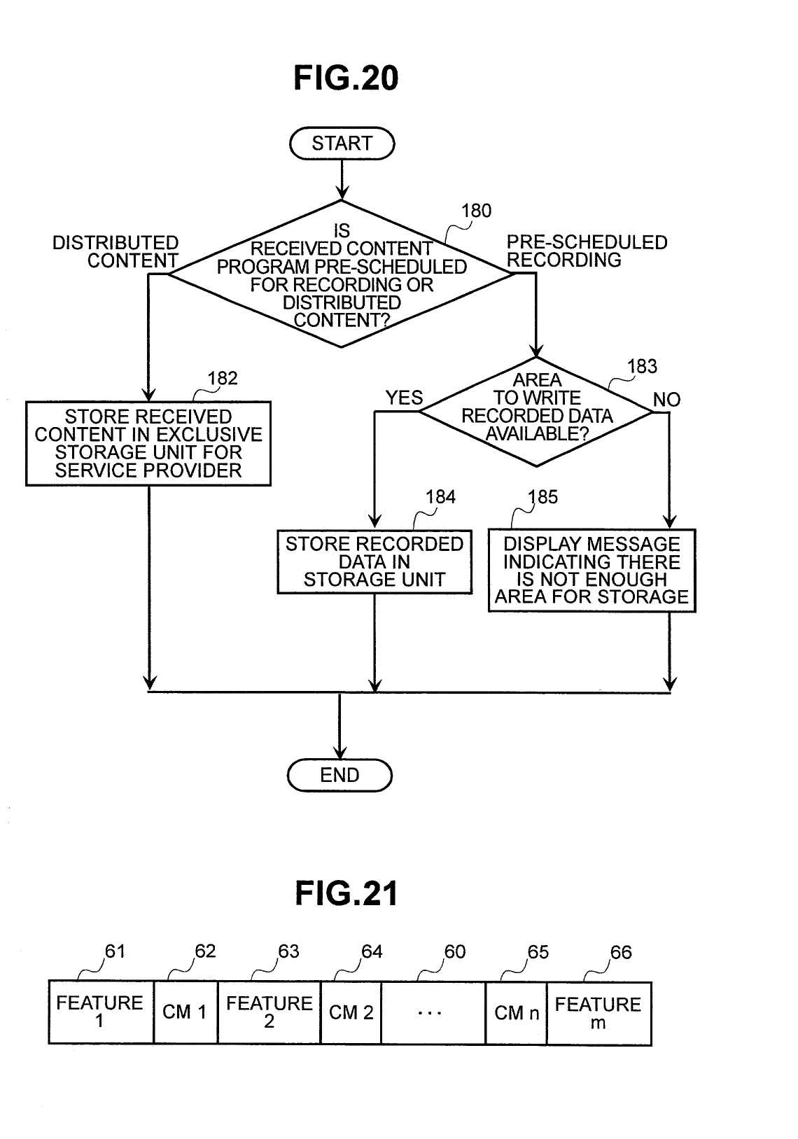

FIG. 20 illustrates a process flowchart of the write control means 37 in the third embodiment.

As shown in FIG. 20, the write control means 37 first determines whether the received content data is broadcast program data pre-scheduled for recording or a content distributed from a service provider (step 180). Pre-scheduled recording information is prestored in the storage unit 3 as the pre-scheduled recording list table 210. The write control means 37 determines whether or not the received content is a program pre-scheduled for recording by checking if the received content is described in the pre-schedule program list table 210.

It is determined in step 180 whether the received content is a program pre-scheduled for recording or a content distributed from a service provider. In case of digital broadcasting, the substance (video) of content data (program), program attribute information for the content and the EPG are multiplexed in the MPEG-2 format and are transmitted. The ID and channel number of the received content data are included in the program attribute information. Upon reception of content data, therefore, the contents of the pre-schedule program list table 210 are searched based on the program ID, the channel number, the current date and so forth to determine whether or not the received content data is a program pre-scheduled for recording.

When the received content data is a content distributed from a service provider, information indicating it is stored in the program attribute information or an MPEG-2 private data area. By checking whether or not this information is present, it is determined if the received content data is a content distributed from a service provider.

When it is determined in step 180 that the received content is a content distributed from a service provider, the write control means 37 stores the received content in the exclusive storage unit 9 (step 182).

When it is determined in step 180 that the received content is a program pre-scheduled for recording, it is determined whether or not the storage unit 3 has an area capable of storing the content (step 183). When it is determined that the content can be stored in the storage unit 3, the received content is stored in the storage unit 3 (step 184). When there is not an enough area to store the content in step 183, information indicating such is displayed on the output unit 7 (step 185) after which the process is terminated.

According to the third embodiment, as apparent from the above, as an exclusive storage unit for a service provider which stores a content to be distributed by a service provider (via a broadcasting provider) is separately attached to the data receiving apparatus, the method of controlling writing to the exclusive memory area without using the exclusive-memory-area management table 200 or 240.

A program recording system as a fourth embodiment is described below.

Although the method of managing an exclusive memory area according to either the first or second embodiment is adaptable to the method of managing an exclusive memory area according to the fourth embodiment, the exclusive-memory-area managing method according to the first embodiment is adapted in the following description.

In the fourth embodiment, CM data is distributed by the service provider or service center system 12 based on a certain strategy. When received by the data receiving apparatus 20, the CM data is not displayed on the output unit 7, but is stored in the storage unit 3 according to the contents of the exclusive-memory-area management table 200. When the user views (displays) a recorded program including CM data, the CM in the program is replaced with the CM previously distributed and stored in the storage unit 3 under a certain condition.

CM data to be distributed in advance is accompanied with attribute information. The attribute information that is stored in the storage unit 3 is managed by the CM data management table 220.

According to the fourth embodiment, the feature of a program and a CM included in the program are stored as separate files at the time the program is recorded.

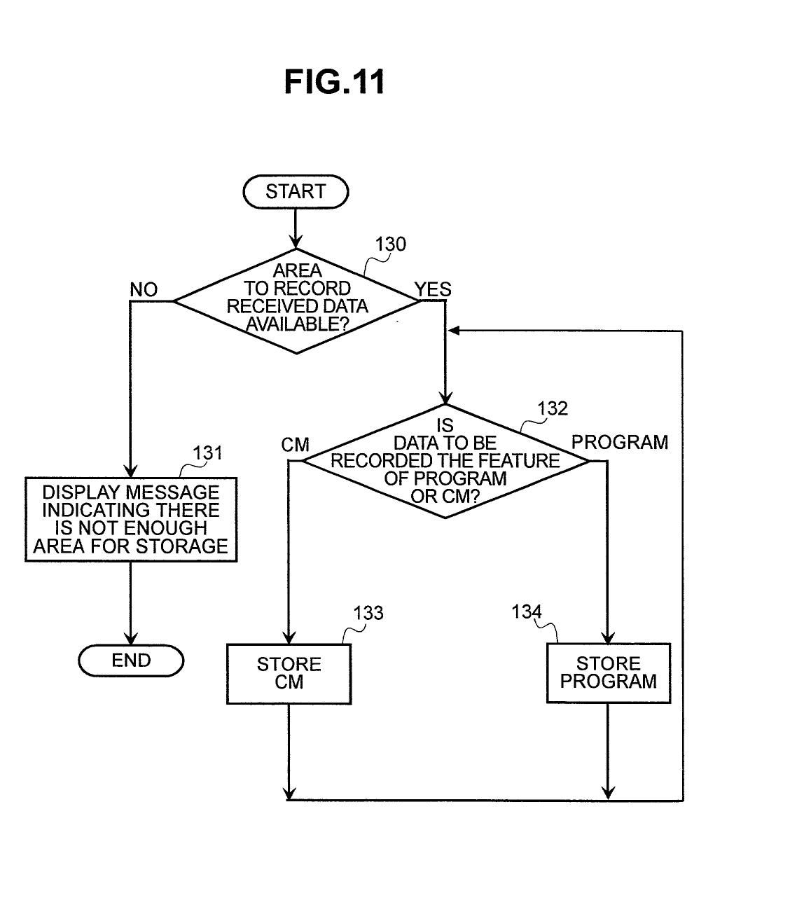

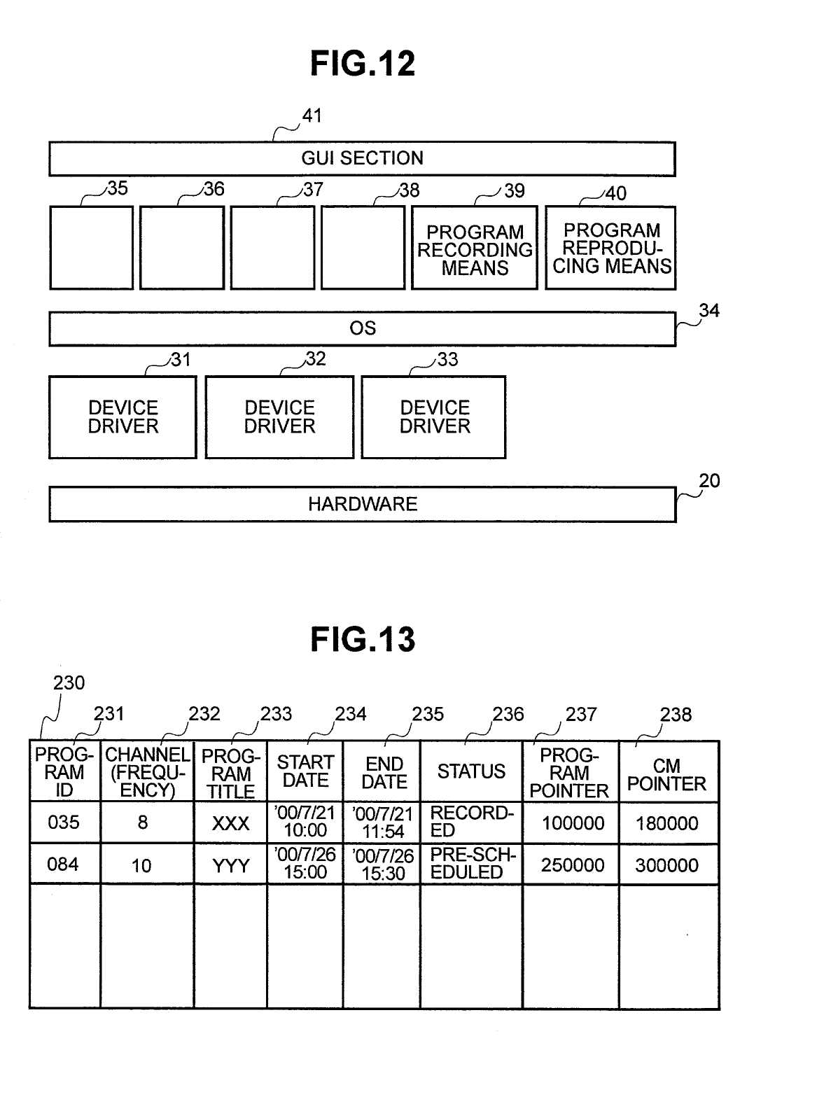

FIG. 11 illustrates a process flowchart of program recording means 39. The program recording means 39 is one of software programs which run on the data receiving apparatus 20 and has a software structure as shown in FIG. 12, which runs on the data receiving apparatus 20.

The program recording means 39 is activated when a program is recorded.

As shown in FIG. 11, the program recording means 39 first determines whether or not there is an area where the user can record data and the area is large enough to store content data (the general term for the main part or feature of a program and a CM) by referring to the exclusive-memory-area management table 200 (step 130). When there is no recordable area or there is not an area large enough to store content data, a message to that effect is displayed on the output unit 7 (step 131) after which the process is terminated.

When there is a recordable area or there is a sufficient area to store content data, it is determined whether the content that is currently received (to be recorded) is the feature of a program or a CM (step 132). Normally, a CM is inserted before, after or in a middle of a program to be broadcast. In the CM, information indicating a CM and a service provider ID indicating which service provider has provided the CM are included in program attribute information to be distributed (broadcast) at the same time or an MPEG-2 private area.

In case where the program attribute information includes information indicating a CM, for example, it is achieved as follows.

Association of Radio Industries and Businesses defines the program arrangement information in digital broadcasting in “ARIB STD-B10 Ver. 1.2, standards for the program arrangement information that is used in digital broadcasting”, issued in May 5, 2000 by Association of Radio Industries and Businesses. The use of the defined program arrangement information can allow a CM to be identified.

According to the standards, information representing program attribute information includes EIT (Event Information Table), LIT (Local event Information Table) and ERT (Event Relation Table) . EIT describes information about one program (broadcasting date, a content, etc). LIT describes information about invents in one program described in the EIT (start time, a content, etc.). ERT describes the relationship among events in each program described in the LIT.

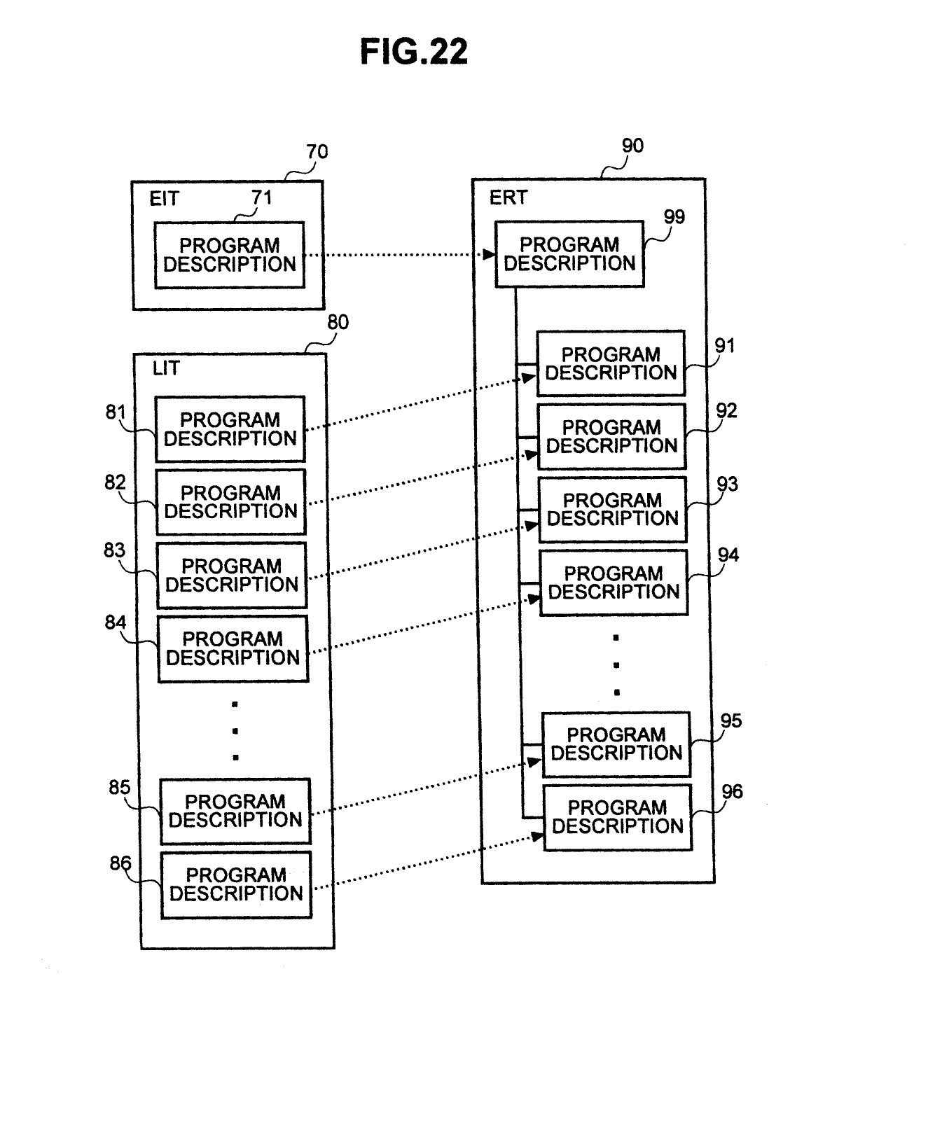

Suppose a program 60 shown in FIG. 21 has been broadcast. The program 60 has n (n being 0 or larger) CMs inserted in the feature of the program. FIG. 22 shows the relationship among the EIT, LIT and ERT in this case.

In FIG. 22, an EIT 70 includes an entry 71 which describes information of the program 60 shown in FIG. 21. The entry 71 describes the event ID, the broadcasting date, the continuation time, the program title and the content of the program 60.

An LIT 80 includes entries 81, 82, 83, 84, 85 and 86 which respectively describe individual pieces of event information of a feature 1 (61), a CM 1 (62), a feature 2 (63), a CM 2 (64), . . . , CMn (65) and a feature m (66). Described in each entry are the local event ID of each event, the start time, the continuation time, the local event title and the content thereof, and an identifier indicating whether each event is a program feature or CM.

An ERT 90 includes entries 99, 91, 92, 93, 94, 95 and 96 which describe the relationship among events included in the entry 71 included in the EIT 70 and the individual entries included in the LIT 80. Described in each entry are the relationship between the program and each local event or the relationship between the local events and the identifier of the information provider of each local event.

The correlation among the entries of the EIT 70, LIT 80 and ERT 90 is determined based on whether or not the contents of the descriptors held by the individual entries (the broadcasting date, the continuation time, the program title, the content thereof, etc.) match with one another. In FIG. 22, the entry 71 and the entry 99 hold matched descriptors. So do the entry 81 and the entry 91, the entry 82 and the entry 92, the entry 83 and the entry 93, the entry 84 and the entry 94, the entry 85 and the entry 95, and the entry 86 and the entry 96.

Returning to FIG. 11, the contents of the descriptors of the entries 81 to 86 are acquired to determine if currently received data is a CM in step 132.

When it is determined that the received data is CM data, the CM data is stored in the exclusive memory area (step 133). When it is determined that the received data is a program feature, the program data is stored in the exclusive memory area (step 134). Then, the process is repeated until recording ends or the program ends.

The CM data and program data that are to be stored in steps 133 and 134 respectively are stored as separate files, and those information are managed by a recorded-program management table 230.

The contents of the recorded-program management table 230 are illustrated in FIG. 13. The recorded-program management table 230 should not necessarily be located in the exclusive memory area.

In FIG. 13, the recorded-program management table 230 comprises a program ID 231, a channel number (frequency) 232, a program title 233, a start date 234, an end date 235, a status 236, a program pointer 237 and a CM pointer 238.

The program ID 231, channel number (frequency) 232, program title 233, start date 234, end date 235, status 236 and program pointer 237 are the same as the program ID 211, channel number (frequency) 212, program title 213, start date 214, end date 215, status 216 and program pointer 217 in the pre-schedule program list table 210.

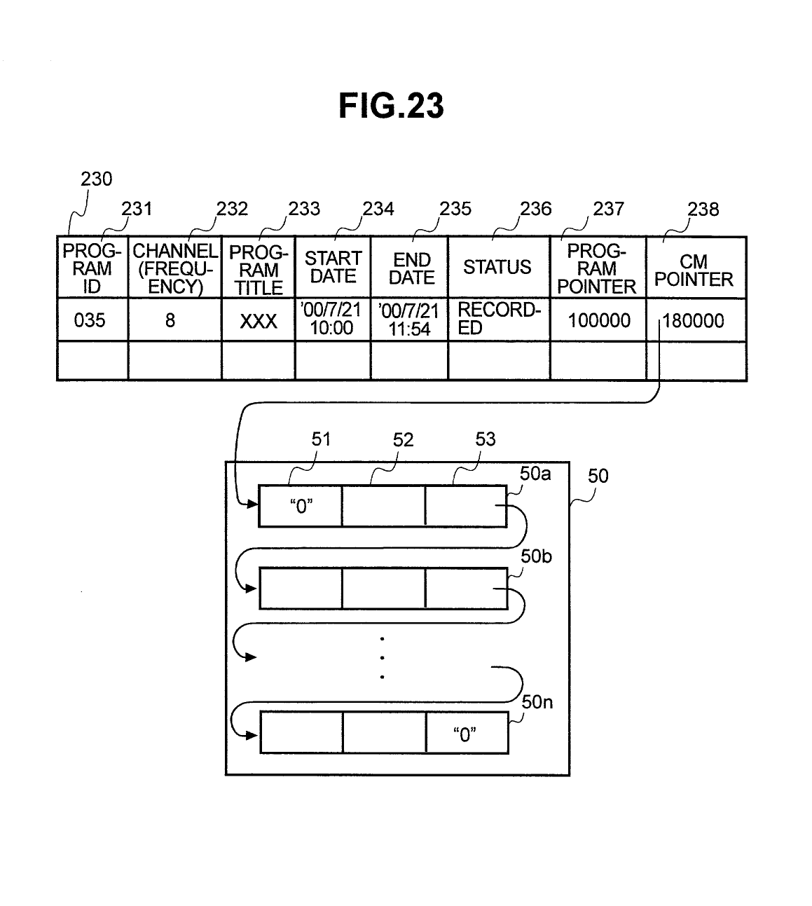

Set in the CM pointer 238 is information which indicates the first entry (node) of a CM list for holding the address of an area where each CM data recorded is stored. FIG. 23 shows the structure of the contents of a CM list 50 when the program recording means 39 in FIG. 11 records the program 60 in FIG. 21. Possible information that specifies a node is, for example, the address of an area where the node is stored.

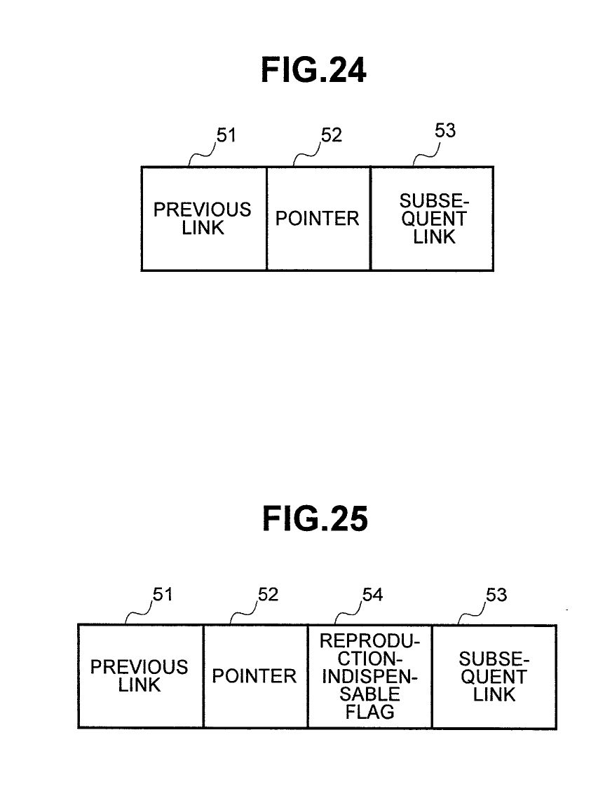

As shown in FIG. 23, the CM list 50 has a single entry (node) formed for each CM data and is constructed by a chain of those nodes. The structure of each node is shown in FIG. 24.

As shown in FIG. 24, a single node comprises a previous link 51, a pointer 52 and a subsequent link 53.

Set in the previous link 51 is information indicating a node to CM data recorded immediately before. Set in the pointer 52 is the address of the area where the recorded CM data is stored. Set in the subsequent link 53 is information indicating a node to CM data recorded immediately after. Information indicating that there is no link information (e.g., “0”) is set in the previous link 51 of the first node and the subsequent link 53 of the last node.

The CM list 50 shown in FIG. 23 is a CM list prepared when, for example, the program 60 shown in FIG. 21 is recorded. In this case, therefore, the CM list 50 comprises n nodes, node 1 (50a), node 2 (50b), . . . , and node n (50n) In the first embodiment, the recorded-program management table 230 may be used in place of the pre-schedule program list table 210.

With the contents of the program ID 231, the channel number 232, the program title 233, the start date 234, the end date 235, the status 236, the program pointer 237 and the CM pointer 238 as a set (entry), the recorded-program management table 230 is finally constructed by zero or more entries.

The CM data that is stored in step 133 in FIG. 11 is stored in the area specified by the content of the pointer 52 in the CM list 50 and the program data that is stored in step 134 is stored in the area specified by the content of the program pointer 237 in the recorded-program management table 230.

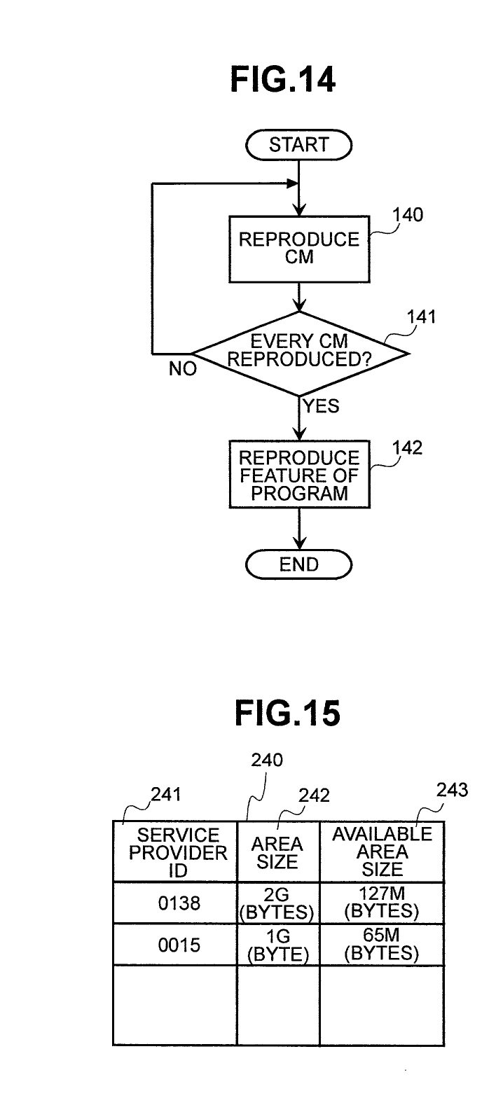

FIG. 14 illustrates a process flowchart of program reproducing means 40. The program reproducing means 40 is one of software programs which run on the data receiving apparatus 20 and has a software structure as shown in FIG. 12, which runs on the data receiving apparatus 20.

The program reproducing means 40 is activated at the time of reproducing a recorded program (when the contents of the recorded-program management table 230 are displayed on the output unit 7 and the user specifies a program included in the recorded-program management table 230 by using the input unit 6).

As shown in FIG. 14, the program reproducing means 40 first reproduces CM data by referring to the CM pointer 238 in the recorded-program management table 230 which is associated with the selected program (step 140). In reproducing CM data, the program reproducing means 40 refers to the CM list 50 generated by the program recording means 39. First, the program reproducing means 40 acquires a first node to CM data by referring to the CM pointer 238 in the recorded-program management table 230 and reproduces the CM data that is stored in the area specified by the pointer 52 of the node. Further, the program reproducing means 40 refers to the content of the subsequent link 53 of the node. If there is a next node, the program reproducing means 40 acquires the node specified by the content of the subsequent link 53 and reproduces the CM data of that node. This operation is repeated to reproduce every CM data until no CM data remains (until the content of the subsequent link 53 indicates no link information).

The program reproducing means 40 then determines whether or not all pieces of CM data stored at the addresses indicated by the contents of the CM pointer 238 are reproduced (viewed) (step 141). Then, the program reproducing means 40 reproduces program data referring to the program pointer 237 in the recorded-program management table 230 (step 142).

When reproduction of CM data is interrupted or skipped in step 140, i.e., when CM data has not been reproduced completely, it is determined that the CM data has not been reproduced, so that the program data will not be reproduced.

The following is a possible reference for determining if CM data has been reproduced completely. In case of digital broadcasting, CM data is broadcast in the MPEG-2 format. In step 140, therefore, a decoding process for MPEG-2 data is carried out. The decoded results are uncompressed digital audio data and uncompressed digital image data (image data) . Here, one should determine whether or not uncompressed digital image data has appeared at a certain point of time or at a certain interval. In case where CM data has not been reproduced or has been skipped, the image data does not appear, so that one can determine that the CM data has not been reproduced completely. In case of fast forward reproduction, generally, only I-pictures of the MPEG-2 format are often reproduced. Therefore, designating P-pictures or B-pictures, not I-pictures, as image data to be used in the decision making step reduces erroneous recognition.

Whether or not specific CM data has been reproduced may be determined as a reproduction condition for CM data for reproducing program data.

For example, a flag indicating if reproduction of CM data to be broadcast is needed to reproduce the feature of a program is multiplexed in program attribute information of the CM data and is broadcast in this form. When the program recording means 39 records CM data and produces a CM list, the flag is stored in the CM list. As shown in FIG. 25, for example, a reproduction-indispensable flag 54 is newly provided for each entry (node) in the CM list 50 and the aforementioned flag is stored in the reproduction-indispensable flag 54. In step 141, one should only determine whether or not CM data for which the flag indicating that reproduction is indispensable has been reproduced completely.

At the time of reproducing CM data in step 140, a CM can be replaced and inserted by the method that has been discussed in the foregoing description of the first embodiment.

According to the program recording system of the fourth embodiment, as apparent from the above, as CM data and program data are stored in separate files, a CM is not inserted while the user is viewing the feature of the program so that the user can enjoy viewing program feature. Because viewing the feature of the program is disabled unless a CM is viewed, a service provider is guaranteed that the CM is viewed. This can improve the degree of popularity of the service provider (CM provider) and the product or service provided by the provider.

In the foregoing description of the first to fourth embodiments, an example where CM data is stored in an exclusive memory area secured in the storage unit 3 in the data receiving apparatus 20 or in an exclusive memory area in the exclusive storage unit 9 for a service provider has been illustrated. The following describes, as a fifth embodiment, a movie-content distributing (rental video) system that stores movie contents in an exclusive memory area secured in the storage unit 3 in the data receiving apparatus 20 or in an exclusive memory area in the exclusive storage unit 9.

In the fifth embodiment, a service provider is a movie distributing agency or a rental video provider. A movie content provided by the service provider is transmitted to the service center system 12 and is managed in the content database 13b connected to the distribution server 13a.

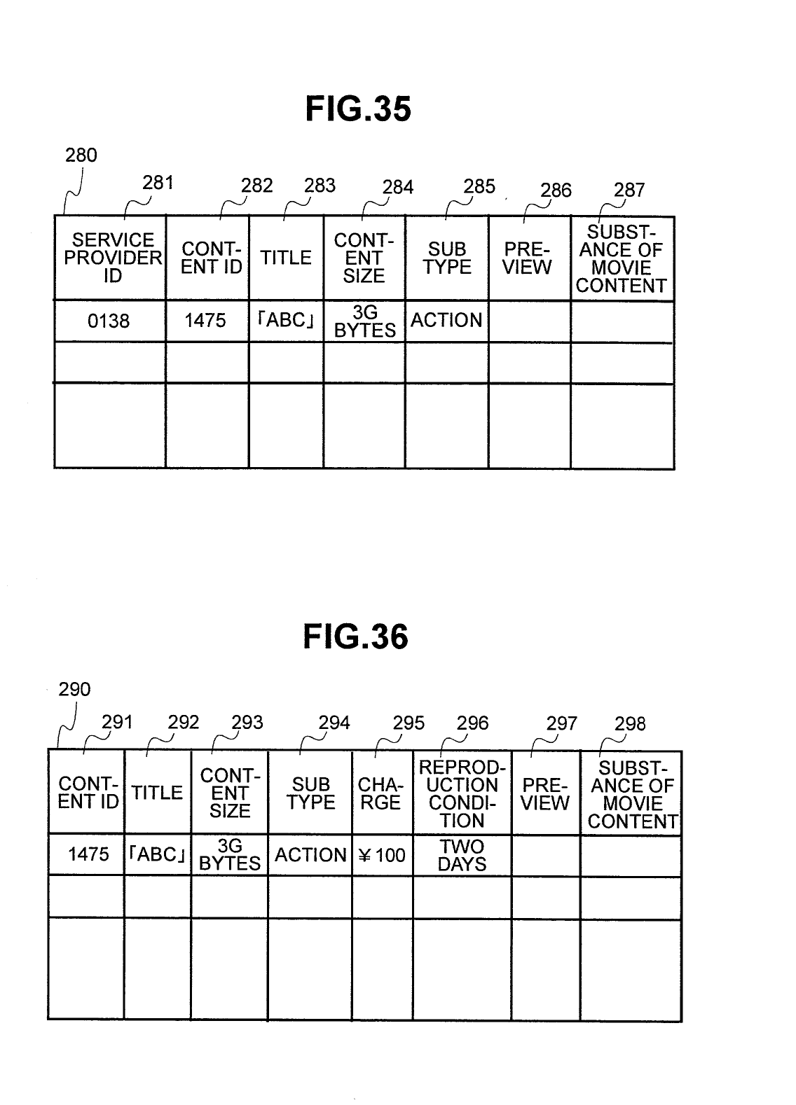

FIG. 35 shows the contents of a movie-content management table 280 which is stored in the content database 13b and managed by the distribution server 13a.

The movie-content management table 280 comprises a service provider ID 281, a service provider ID 281, a content ID 282, a title 283, a content size 284, a content sub type 285, a preview 286 and a movie-content's substance 287.

Set in the service provider ID 281 is a unique ID indicating the provider (service provider) of a content specified by the content ID 282. It is desirable that assigning an ID (for each service provider) which should be held in the service provider ID 281 is the same as an ID (for each service provider) which should be held in the service provider ID 201 shown in FIG. 5. That is, when the content of the service provider ID 201 shown in FIG. 5 is “0138” and the content of the service provider ID 281 is “0138”, the service providers that are specified by the service provider ID 201 and the service provider ID 281 are identical.

Set in the content ID 282 is a unique ID given to every content.

Set in the title 283 is the title of the content specified by the content ID 282.

Set in the content size 284 is the size (memory capacity or storage time duration) required when the content specified by the content ID 282 is stored in the exclusive memory area.

Set in the content sub type 285 is the genre attribute of the content specified by the content ID 282. The genre attribute indicates, for example, information, such as an action, horror or comedy.

The preview or digest of the content specified by the content ID 272 or the substance of a preview content is stored in the preview 286.

The content data that is specified by the content ID 272 itself is stored in the content's substance 287.

In the fifth embodiment, the title of a content to be transmitted to the distribution server 13a from the service provider and a content sub type are designated as attributes for this content. Further, the preview or digest of the content or a preview content is added to the content to be transmitted. The attributes are respectively set in the title 283 and the content sub type 285, and the preview or digest or the preview content is stored in the preview 286.

With the contents of the service provider ID 281, the content ID 282, the title 283, the content size 284, the content sub type 285, the preview 286 and the content's substance 287 as a set (entry), the movie-content management table 280 is finally constructed by zero or more entries. With respect to the service provider ID 281, there may be entries for plural contents.

The content data and the preview thereof (or the digest or a preview content) are sent to the distribution server 13a from each service provider system over the network 23. When receiving the content data and preview thereof sent from each service provider system, the distribution server 13a assigns a content ID to the content data and adds an entry, together with the ID for the content-transmitted service provider, in the movie-content management table 280 in the content database 13b.

The content data and preview thereof sent from the service provider may be input to the distribution server 13a via a recording medium such as DVD-ROM. In this case, an entry to the movie-content management table 280 for the content data is added as the operator of the distribution server 13a inputs necessary information based on the information displayed on the display unit 315 while manipulating the input unit 314.

The contents of the movie-content management table 280 (those of the preview 286, the content's substance 287, the service provider ID 281, the content ID 282 and the title 283 or the content size 284 or the content sub type 285 which are needed to be distributed) and the contents of the charge information management table 260 (the charge 264 and the reproduction condition 265 for the content ID) are distributed to the data receiving apparatus 20 via the broadcasting provider system 15 or 16, and are stored (accumulated) in the exclusive memory area for the service provider that has provided the content to be distributed.

When the content data is distributed to the data receiving apparatus 20 from the broadcasting provider system 15 or 16, the content of the content's substance 287 is subjected to some kind of encryption in the distribution server 13a or the charge server 14a in order to prevent illegitimate copying, but the content of the preview 286 is not encrypted. This means that to view the preview itself, the user need not undergo a purchase process and can view it free. That is, as the user is permitted to view the preview freely, it is possible to improve the user's wishes to buy a (pay) movie content itself. Making the distribution schedule of contents in accordance with the contents of the client information 252 and the history 253 in the client information management table 250 can further improve the user's wishes to buy.

While a content to be distributed is compressed by the MPEG-2 format or the like before distribution, a preview (or a digest or a preview content) is likewise compressed before distribution. The content data and the preview thereof (or the digest or preview content) may be compressed in the same compression format or compressed in different compression formats. For example, while content data may be compressed in the MPEG-2 format and the preview thereof (or the digest or preview content) may be compressed in the MPEG-4 format.

A description will now be given of content viewing/buying means in the data receiving apparatus 20.

The contents that have been received by the data receiving apparatus 20 and stored in an exclusive memory area are managed by a stored-content management table 290. The contents of the stored-content management table 290 are illustrated in FIG. 36. The stored-content management table 290 should not necessarily be located in the exclusive memory area.

In FIG. 36, the stored-content management table 290 comprises a content ID 291, a title 292, a content size 293, a content sub type 294, a charge 295, a reproduction condition 296, a preview 297 and a movie-content's substance 298.

The content ID 291, the title 292, the content size 293 and the content sub type 294 are respectively same as the content ID 282, the title 283, the content size 284 and the content sub type 285 in the movie-content management table 280. The charge 295 and the reproduction condition 296 are respectively identical to the charge 264 and the reproduction condition 265 in the charge information management table 260.

Set in the preview 297 is the address where a preview (or a digest or preview content) is stored.

Set in the movie-content's substance 298 is the address where the substance of a movie content is stored. With the contents of the content ID 291, the title 292, the content size 293, the content sub type 294, the charge 295, the reproduction condition 296, the preview 297 and the movie-content's substance 298 as a set (entry), the stored-content management table 290 is finally constructed by zero or more entries.

With respect to one content ID 291, there may be plural sets of charges 295 and reproduction conditions 296.

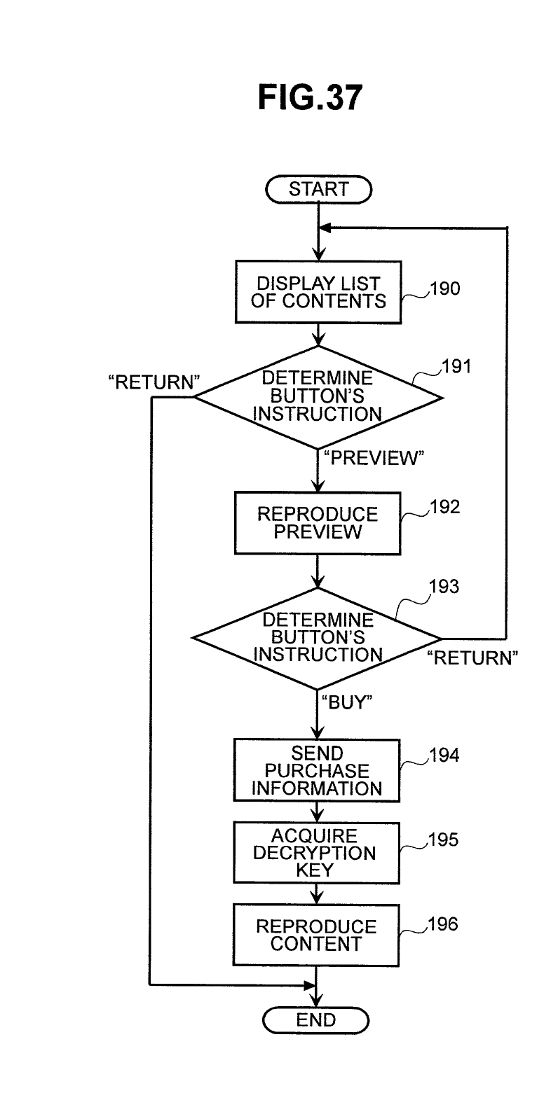

FIG. 37 illustrates a process flowchart of the content viewing/buying means. The content viewing/buying means is a software program stored in main memory 2 or the storage unit 3 of the data receiving apparatus 20 and is realized as the CPU 1 runs the program upon occurrence of some event, such as inputting of an instruction (operation) to display a stored-content list by the user using the input unit 6 or reception of content data.

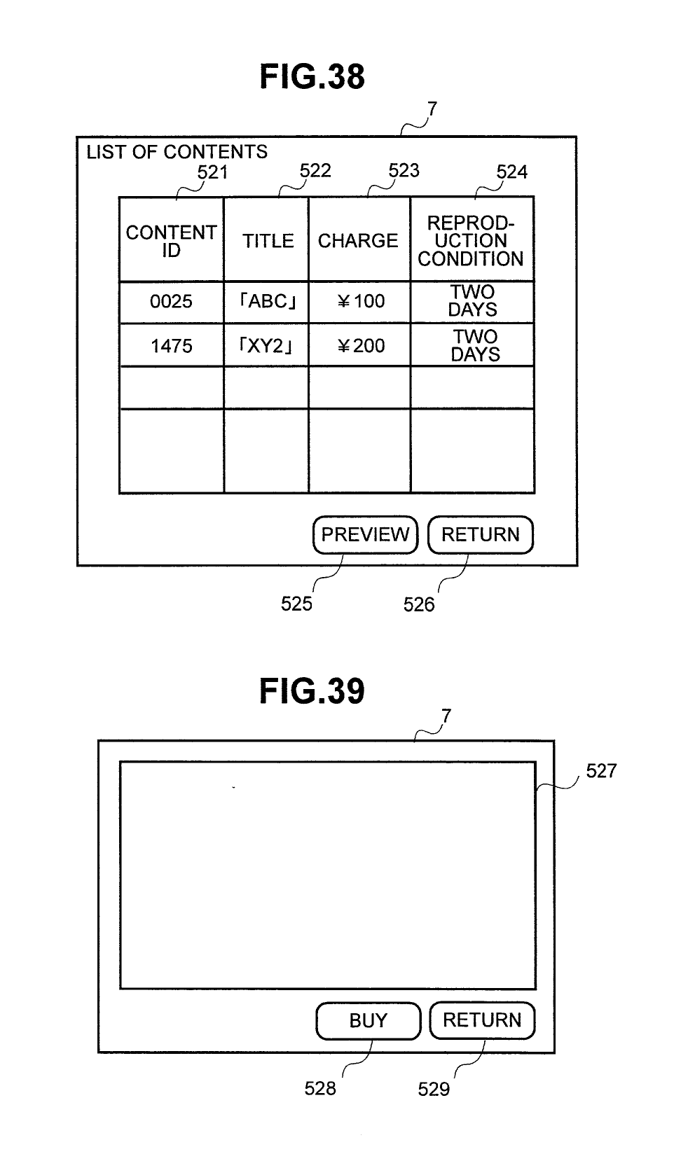

As shown in FIG. 37, the content viewing/buying means first displays a list of contents stored in the exclusive memory area (step 190). In displaying the list of contents stored in the exclusive memory area, the contents of the stored-content management table 290 are displayed. An example of a screen displayed then on the output unit 7 is shown in FIG. 38.

The list of contents includes at least a content ID 521, a content's title 522, a content's charge 523 and a content's reproduction condition 524. The user can select one content in the content list using the input unit 6. In this case, if the way the selected content is displayed is made different from the way unselected other contents are displayed, the user can easily recognize the selected content. The screen shown in FIG. 38 shows at least a PREVIEW button 525 and a RETURN button 526.

Returning to FIG. 37, the content viewing/buying means then determines whether or not the user has specified the button 525 or the button 526 (step 191). When the RETURN button 526 is specified, the process is terminated. When the PREVIEW button 525 is specified, the preview of the selected content (or the digest or the preview content) is reproduced and displayed on the output unit 7 (step 192). The reproduction of the preview is executed by the receiving unit 5 or the CPU 1. FIG. 39 shows an example of a screen when the preview is reproduced and displayed on the output unit 7.

In FIG. 39, “527” is a screen on which the preview is reproduced and displayed, “528” is a BUY button, and “529” is a RETURN button.

The preview is reproduced and displayed on the screen 527. Next, the content viewing/buying means determines whether or not the user has specified the button 528 or the button 529 (step 193). When the RETURN button 529 is specified, the process is returned to step 190. When the BUY button 528 is specified, the content viewing/buying means prepares communication data having the structure specified by the data structure 320 that indicates purchase of the content from the content ID 521 and the reproduction condition 524 for the preview and the user ID of the data receiving apparatus 20, and sends the communication data to the charge server 14a over the network 21 (step 194). Thereafter, as a decryption key for the content bought is sent from the charge server 14a as a response to the communication data, the content viewing/buying means acquires the decryption key (step 195), reproduces the content using the decryption key and displays the content on the output unit 7 (step 196). Then, the content viewing/buying means terminates the process.

As the content distributing system according to the fifth embodiment distributes a preview content free to view as well as a pay content to the data receiving apparatus 20, the user can grasp the general content through the preview content before buying the content so that the user's wishes to buy the content can be increased.

Although the movie-content distributing system is illustrated as an example in the foregoing description of the fifth embodiment, contents are not limited to movie contents. The invention can be adapted to distribution of music or game contents as well.

Through the application of the above-described invention, the following business model is feasible. When a service provider is an advertising agency, for example, the service provider system 10 or 11 in FIG. 1 becomes an advertising agency system. Upon requested by an advertising client (client), the advertising agency produces a commercial (CM), which is distributed (broadcast on TV) by the broadcasting provider system 15 or 16 in FIG. 1, the data receiving apparatus 20 receives the broadcast CM and the user views the CM.

The advertising agency increases its income by accepting requests of making commercials from a larger number of companies and institutes, and the clients of the advertising agency increase the profits as viewers (users) view the CMs of the clients and become more interested in buying products.

However, the conventional combination of TV broadcasting of CMs and TV receivers is targeted for an unspecific number of people and the time-shift viewing tends to be catching the popularity. This raises such a problem that the freshness of CMs cannot be maintained and a sufficient CM effect cannot be expected.

A better CM effect can be expected by newly providing a service center to intensively manage CM data to be distributed (broadcast), securing an area for each advertising agency (service provider) in the storage unit (HDD) of the data receiving apparatus, storing a CM produced by each advertising agency in the area, and replacing a CM in a content with the stored content and displaying the CM on the output unit of the data receiving apparatus at the time of time-shift viewing as done in the invention.

Further, a much greater CM effect can be expected by combining the present system with the method of replacing a CM with one that matches the need of a viewer in accordance with the profile of the viewer as taught by the prior art (JP-A No. 259930/1999). As the application of the invention improves the CM effect, a client can expect an increase in the profit by the sales of commodities and products originated from an increase in the viewers'wishes to buy.

Furthermore, as the advertising agency secures exclusive memory areas in a greater number of data receiving apparatuses, an increase in the number of CM production requests is expected. As the service center monitors the exclusive memory areas in the data receiving apparatuses, manages distributed CM data and performs a charging process on be half of advertising agencies or the like in case of services that involve charging, such as TV commerce, in linkage with CMs, the service center can earn fees from the advertising agencies or the like.

For broadcasting providers, the versatility of CM viewing forms brings about new CM broadcasting strategies, resulting in an expected increase in advertising fees earned. Further, if makers which manufacture and sell data receiving apparatuses produce and sell apparatuses having a capability of securing an exclusive memory area for each service provider as in the invention, they can expect incentive (kickback) from advertising agencies or the like. This business model can be accomplished unless the data receiving apparatus has the above-described capability and will be become popular unless the users are provided with the data receiving apparatuses at a low cost. The kickback can help provide the users with the data receiving apparatuses at a low cost.

In case of transmitting pay data to data receiving apparatuses, it is preferable that the price of pay data to be transmitted to a data receiving apparatus which has an exclusive memory area should be made lower (discounted) than the price of pay data to be transmitted to a data receiving apparatus which does not have an exclusive memory area.

In case of transmitting pay data to data receiving apparatuses, the price of pay data to be transmitted to a data receiving apparatus, for which the size of the memory area secured as an exclusive memory area is large, is made lower (discounted) than the price of pay data to be transmitted to a data receiving apparatus for which the size of the memory area secured as an exclusive memory area is small.

The fee for using a network connected to a data receiving apparatus which has an exclusive memory area is made lower (discounted) than the fee for using a network connected to a data receiving apparatus which does not have an exclusive memory area.

The fee for using a network connected to a data receiving apparatus, for which the size of the memory area secured as an exclusive memory area is large, is made lower (discounted) than the fee for using a network connected to a data receiving apparatus for which the size of the memory area secured as an exclusive memory area is small.

The selling price of a data receiving apparatus which has an exclusive memory area is made lower (discounted) than the selling price of a data receiving apparatus which does not have an exclusive memory area.

The selling price of a data receiving apparatus, for which the size of the memory area secured as an exclusive memory area is large, is made lower (discounted) than the selling price of a data receiving apparatus for which the size of the memory area secured as an exclusive memory area is small.

It is preferable that a service provider or broadcasting provider should pay for the differences obtained by the discount. That is, as the maker or seller of the data receiving apparatus secures an exclusive memory area in the data receiving apparatus before selling it or secures an exclusive memory area in the data receiving apparatus when the data receiving apparatus is connected to a service center system, the service provider or broadcasting provider is guaranteed with a predetermined size of an exclusive memory area and the maker or seller of the data receiving apparatus collects incentive from the service provider or broadcasting provider which has secured the exclusive memory area. The incentive earned in case where the size of the memory area secured as an exclusive memory area is large is made greater than the incentive earned in case where the size of the memory area secured as an exclusive memory area is small. It is preferable that those advantages should be defined in a contract before manufacturing or selling the data receiving apparatus.

Further, the user can always view a CM with fresher information and can acquire more useful information than provided by the prior art.

According to the embodiment of the invention, an exclusive memory area for a service provider is secured in the storage unit of the data receiving apparatus, the service provider distributes CM data based on a plan (strategy) and stores it in the exclusive memory area, and a CM can be reproduced timely at the time of time-shift viewing (reproduction while recording) of a program. This can provide a data storage type service method and a data storage type data receiving apparatus which can supply a user with a reliable and flexible service.

The invention can also provide a data storage type service method and a data storage type data receiving apparatus which can store a CM distributed beforehand in a storage unit incorporated in the TV broadcast receiving apparatus (data receiving apparatus) together with the expiration period of the CM and can replace a CM included in a recorded program with the CM with a valid expiration period stored in the storage unit when the date of the CM included in the recorded program has no significance.

Moreover, the invention can provide a data storage type service method and a data storage type data receiving apparatus which record a CM and the main part or feature of a TV program as separate files, in case where a CM is included in a TV program to be recorded, at the time of recording the TV program and allow a user to view the feature of the TV program on the condition that the user views the CM at the time of time-shift viewing.

The invention is useful for a data receiving apparatus and a data receiving method which can allow a data provider or sender to reliably provide a viewer (user) with a service (information, a product or the like).

The foregoing invention has been described in terms of preferred embodiments. However, those skilled, in the art will recognize that many variations of such embodiments exist. Such variations are intended to be within the scope of the present invention and the appended claims.

What is claimed is:

1. A data receiving apparatus for receiving data transmitted via a broadcast wave or an electric communication line, comprising:
a receiving unit for receiving said data;
a storage unit for storing received data; and
a processing unit for securing in said storage unit an exclusive memory area exclusively usable by a provider or a sender of said data.

2. The data receiving apparatus according to claim 1,wherein said storage unit has a user memory area for storing received data in accordance with an instruction from a user of said data receiving apparatus.

3. The data receiving apparatus according to claim 2, wherein said processing unit displays on a display unit at least one of an entire memory capacity, an entire storage time duration, an unused memory capacity, a remaining storage time duration, a used memory capacity and a memory-used time duration of said user memory area.

4. The data receiving apparatus according to claim 1, wherein said processing unit transmits an entire memory capacity or an entire storage time duration onto an electric communication line in accordance with a predetermined schedule, upon reception of a request over said electric communication line or upon detection of occurrence of a damage of said exclusive memory area.

5. The data receiving apparatus according to claim 1, wherein based on an identifier added to received data, said processing unit determines if said received data is data to be stored in said exclusive memory area.

6. The data receiving apparatus according to claim 1, wherein said storage unit has a plurality of exclusive memory areas physically or logically separated from one another in association with a plurality of providers or senders.

7. A data receiving method of receiving data transmitted via a broadcast wave or an electric communication line, comprising the steps of:
securing in a storage unit an exclusive memory area exclusively usable by a provider or a sender of said data; and
storing received data in said exclusive memory area when said received data is what is desired by said provider or sender to be stored in said exclusive memory area.

8. A service center apparatus for managing a data receiving apparatus via an electric communication line, comprising:
means for communicating with said data receiving apparatus; and
means for determining if an exclusive memory area exclusively usable by a provider or a sender of said data has been secured in a storage unit of said data receiving apparatus.

9. A data receiving apparatus managing method of managing a data receiving apparatus via an electric communication line, comprising the step of:
determining if an exclusive memory area exclusively usable by a provider or a sender of said data has been secured in a storage unit of said data receiving apparatus.

10. The data receiving apparatus managing method according to claim 9, further comprising the step of determining at least one of an entire memory capacity and an entire storage time duration of said exclusive memory area.

11. A data receiving apparatus for receiving data transmitted via a broadcast wave or an electric communication line, comprising:
a receiving unit for receiving said data; and
a storage unit which stores said data and has a plurality of memory areas logically or physically separated from one another,
wherein at least one of said plurality of memory areas is a restricted memory area subjected to restriction of at least one of writing, reading, alteration and deletion of said data based on an instruction from a user of said data receiving apparatus.

12. The data receiving apparatus according to claim 11, wherein those memory areas which are other than said restricted memory area store main data about a broadcast program; and
said restricted memory area stores sub data about a commercial, commodity sales, service providing offer, commodity or service catalog.

13. The data receiving apparatus according to claim 12, further comprising a processing unit for changing sub data included in said main data to said sub data stored in said restricted memory area and displaying said main data containing said changed sub data on a display unit.

14. The data receiving apparatus according to claim 13, wherein said processing unit changes sub data included in said main data to said sub data stored in said restricted memory area when making a decision that an expiration period of said sub data included in said main data has passed.

15. The data receiving apparatus according to claim 13, wherein said processing unit changes sub data included in said main data to said sub data stored in said restricted memory area in accordance with a priority order predetermined for said sub data stored in said restricted memory area.

16. The data receiving apparatus according to claim 12, further comprising a processing unit for inserting said sub data in said main data and displaying that sub-data inserted main data on a display unit.

17. A data receiving method of receiving data transmitted via a broadcast wave or an electric communication line, comprising the steps of:
receiving said data;
storing said data in a storage unit having a plurality of memory areas logically or physically separated from one another; and
restricting at least one of writing, reading, alteration and deletion of said data based on an instruction from a user of said data receiving method with respect to at least one of said plurality of memory areas.

18. A data transmitting apparatus for transmitting data to a data receiving apparatus via a broadcast wave or an electric communication line, comprising:
a processing unit for associating exclusive data to be stored in a restricted memory area, which is located in a storage unit of said data receiving apparatus and is subjected to restriction of at least one of writing, reading, alteration and deletion of said data based on an instruction from a user of said data receiving apparatus, with other data; and
a transmitting unit for transmitting said exclusive data and said other data.

19. The data transmitting apparatus according to claim 18, wherein said processing unit adds an identifier for associating said exclusive data with said other data to at least one of said exclusive data and said other data.

20. The data transmitting apparatus according to claim 18, wherein said processing unit produces a correlation table for associating said exclusive data with said other data; and
said transmitting unit transmits said correlation table.

21. The data transmitting apparatus according to claim 18, wherein said processing unit sets expiration period of said exclusive data based on contents of said exclusive data.

22. A data receiving apparatus for receiving data transmitted via a broadcast wave or an electric communication line, comprising:
a receiving unit for receiving said data;
a storage unit for storing data about a commercial, commodity sales, service providing offer, commodity or service catalog and other data; and
a processing unit for displaying on a display unit said data about said commercial, commodity sales, service providing offer, commodity or service catalog in linkage with said other data,
wherein at least one of alteration and deletion of said data about said commercial, commodity sales, service providing offer, commodity or service catalog based on an instruction from a user of said data receiving apparatus is restricted.

23. A data receiving method of receiving data transmitted via a broadcast wave or an electric communication line, comprising the steps of:
receiving said data;
storing data about a commercial, commodity sales, service providing offer, commodity or service catalog and other data in a storage unit;
displaying on a display unit said data about said commercial, commodity sales, service providing offer, commodity or service catalog in linkage with said other data; and
restricting at least one of alteration and deletion of said data about said commercial, commodity sales, service providing offer, commodity or service catalog based on an instruction from a user of said data receiving apparatus.

24. A data receiving apparatus for receiving data transmitted via a broadcast wave or an electric communication line, comprising:
a receiving unit for receiving said data;
a storage unit for storing a table for managing data a user of said data receiving apparatus desires to record; and
a processing unit for comparing received data with said table, and storing said received data in a restricted memory area in a plurality of memory areas of said storage unit, which is subjected to restriction of at least one of writing, reading, alteration and deletion of said received data according to an instruction from said user, when making a decision that said received data is not described in said table.

25. A data receiving method of receiving data transmitted via a broadcast wave or an electric communication line, comprising the steps of:
receiving an input of an identifier for identifying data a user of said data receiving method desires to record;
producing a table for managing said data whose recording is desired by said user based on said identifier; and
comparing received data with said table when receiving said data, and storing said received data in a restricted memory area subjected to restriction of at least one of writing, reading, alteration and deletion of said received data according to an instruction from said user, when making a decision that said received data is not described in said table.

26. A data receiving apparatus for receiving data transmitted via a broadcast wave or an electric communication line, comprising:
a receiving unit for receiving said data; and
a storage unit which stores said data and has a plurality of memory areas logically or physically separated from one another; and
a processing unit for storing said data in different memory areas in accordance with an identifier added to said data.

27. The data receiving apparatus according to claim 26, wherein said identifier added to said data includes an identifier for identifying contents of said data.

28. The data receiving apparatus according to claim 26, wherein said identifier added to said data includes an identifier for identifying a provider or sender of said data.

29. The data receiving apparatus according to claim 26, wherein a t least one of said plurality of memory areas is a restricted memory area subjected to restriction of at least one of writing, reading, alteration and deletion of said data based on an instruction from a user of said data receiving apparatus; and
data stored in said restricted memory area is output to an output unit in accordance with a predetermined schedule.

30. The data receiving apparatus according to claim 26, wherein at least one of said plurality of memory areas is a restricted memory area subjected to restriction of at least one of writing, reading, alteration and deletion of said data based on an instruction from a user of said data receiving apparatus; and
data stored in said restricted memory area is output to an output unit in linkage with data stored in other memory areas than said restricted memory area.

31. A data receiving method of receiving data transmitted via a broadcast wave or an electric communication line, comprising the steps of:
receiving said data; and
storing said data in different memory areas among a plurality of memory areas in a storage unit, which are logically or physically separated from one another, in accordance with an identifier added to said received data.

32. A data transmitting method of transmitting pay data to a data receiving apparatus, comprising the step of:
setting a price of pay data to be transmitted to that data receiving apparatus, which has an exclusive memory area exclusively usable by a provider or sender of said data, lower than a price of pay data to be transmitted to that data receiving apparatus which does not have said exclusive memory area.

33. A data transmitting method of transmitting pay data to a data receiving apparatus, comprising the step of:
setting a price of pay data to be transmitted to a data receiving apparatus, for which at least one of an entire memory capacity and entire storage time duration of an exclusive memory area exclusively usable by a provider or sender of said data is large, lower than a price of pay data to be transmitted to a data receiving apparatus for which at least one of said entire memory capacity and entire storage time duration of said exclusive memory area is small.

34. A charge collecting method of collecting a fee for using an electric communication line connected to a data receiving apparatus, comprising the step of:
setting a fee for using an electric communication line connected to a data receiving apparatus which has a restricted memory area subjected to restriction of at least one of writing, reading, alteration and deletion of data based on an instruction from a user of said data receiving apparatus, lower than a fee for using an electric communication line connected to a data receiving apparatus which does not have said restricted memory area.

35. A charge collecting method of collecting a fee for using an electric communication line connected to a data receiving apparatus, comprising the step of:
setting a fee for using an electric communication line connected to a data receiving apparatus, for which at least one of an entire memory capacity and entire storage time duration of a restricted memory area subjected to restriction of at least one of writing, reading, alteration and deletion of data based on an instruction from a user of said data receiving apparatus is large, lower than a fee for using an electric communication line connected to a data receiving apparatus for which at least one of said entire memory capacity and entire storage time duration of said restricted memory area is small.

36. A commodity sales method of selling data receiving apparatuses, comprising the step of:
setting a selling price of a data receiving apparatus, which has an exclusive memory area exclusively usable by a provider or sender of data, lower than a selling price of a data receiving apparatus that does not have said exclusive memory area.

37. The commodity sales method according to claim 36, further comprising the step of acquiring, from said provider or sender, a difference between said selling price of said data receiving apparatus which has said exclusive memory area and said selling price of said data receiving apparatus ,which does not have said exclusive memory area.

38. A commodity sales method of selling data receiving apparatuses, comprising the step of:
setting a selling price of a data receiving apparatus, for which at least one of an entire memory capacity and entire storage time duration of an exclusive memory area exclusively usable by a provider or sender of data is large, lower than a selling price of a data receiving apparatus for which at least one of said entire memory capacity and entire storage time duration of said exclusive memory area is small.

39. A commodity sales method of selling data receiving apparatuses, comprising the step of:
acquiring a fee from a data provider or sender of data by guaranteeing a data provider or sender a predetermined memory capacity or storage time duration for an exclusive memory area exclusively usable by a provider or sender of data.

40. The commodity sales method according to claim 39, further comprising the step of setting an amount of said fee in accordance with a size of at least one of an entire memory capacity and an entire storage time duration of said exclusive memory area.

41. The commodity sales method according to claim 39, wherein an amount of a fee obtainable for said exclusive memory area is larger when a capacity of said exclusive memory area is large than when said capacity of said exclusive memory area is small.

42. A data receiving apparatus for receiving data transmitted via a broadcast wave or an electric communication line, comprising:
a receiving unit for receiving said data;
a storage unit for storing received data; and
a processing unit for securing in said storage unit an exclusive memory area exclusively usable by a provider or a sender of said data,
wherein pay data and free data associated with said pay data, both of which are to be transmitted via said broadcast wave or electric communication line, are stored in said exclusive memory area.

43. A data receiving apparatus for receiving data transmitted via a broadcast wave or an electric communication line, comprising:
a receiving unit for receiving said data;
a storage unit for storing received data; and
a processing unit for securing in said storage unit an exclusive memory area exclusively usable by a provider or a sender of said data,
wherein compressed pay data and free data associated with said pay data and compressed in a data compression format different from that of said pay data, both of which are to be transmitted via said broadcast wave or electric communication line, are stored in said exclusive memory area.

44. A data receiving method of receiving data transmitted via a broadcast wave or an electric communication line, comprising the steps of:
securing in a storage unit an exclusive memory area exclusively usable by a provider or a sender of said data; and
storing pay data said provider or sender desires to store in said exclusive memory area and free data associated with said pay data in said exclusive memory area when receiving said pay data and said free data.

45. A data receiving method of receiving data transmitted via a broadcast wave or an electric communication line, comprising the steps of:
securing in a storage unit an exclusive memory area exclusively usable by a provider or a sender of said data; and
storing compressed pay data said provider or sender desires to store in said exclusive memory area and free data, which is associated with said pay data and is compressed in a data compression format different from that of said pay data, in said exclusive memory area when receiving said pay data and said free data.

46. A data receiving apparatus for receiving data transmitted via a broadcast wave or an electric communication line, comprising:
a receiving unit for receiving said data;
a storage unit for storing received data; and
a processing unit for securing in said storage unit a priority memory area which is usable by priority by a provider or a sender of said data with respect to a user of said data receiving apparatus.

47. A service center apparatus for managing a data receiving apparatus via an electric communication line, comprising:
means for communicating with said data receiving apparatus; and
means for determining if a priority memory area usable by priority by a data provider or a data sender with respect to a user of said data receiving apparatus has been secured in a storage unit of said data receiving apparatus.
